(19) United States
(12) Patent Application Publication
(10) Pub. No.: US 2010/0023353 A1
(43) Pub. Date: Jan. 28, 2010

(54) METHOD FOR ESTABLISHING, TRACKING AND AUDITING COMPLIANCE

(76) Inventor: Richard L. Stoffiere, Avon, OH (US)

Correspondence Address: DOBRUSIN & THENNISCH PC, 29 W LAWRENCE ST, SUITE 210, PONTIAC, MI, 48342, US

(21) Appl. No.: 12/212,884

(22) Filed: Sep. 18, 2008

Related U.S. Application Data
(60) Provisional application No. 60/973,901, filed on Sep. 20, 2007.

(51) Int. Cl. G06Q 40/00; G06F 17/30; G06F 15/16; G06Q 10/00; G06Q 50/00; G06F 3/048

(52) U.S. Cl. 705/4; 707/104.1; 709/206; 715/764; 707/E17.009

(57) ABSTRACT

A method and system for tracking and auditing activities against a set of guidelines for an Insurance Law Firm. An automatic process, manual process or both, for receive notifications of upcoming and passed guideline due dates with both prospective and retrospective auditing capabilities. The system is customizable to fit the idiosyncrasies of each user firm, such as client type and billing procedures. It also may utilize the industry standard Universal Task Based Management System (UTBMS) task and activity codes. Additionally, the system may utilize a 3^{rd} party time keeping software database package for the regular input of work time performed and various other data inputs. It also sorts and keeps track of email communications as they relate to specific tasks or matters.

### CLAIM OF PRIORITY

The present application claims the benefit of the filing date of Provisional Application No. 60/973,901 (filed Sep. 20, 2007) the contents of which are hereby incorporated by reference in their entirety.

### FIELD OF THE INVENTION

The invention relates generally to the fields of Insurance Law Practice and Information Technology. More particularly, the invention relates to a system and method for establishing, tracking and auditing compliance with jurisdictional and client case timing and documentation rules so that case tasks are identified and completed promptly.

### BACKGROUND

Insurance claims and insurance litigation consumes billions of dollars each year. Law firms that specialize in insurance matters must proficiently pursue client claims and comply with the strict procedures and systems of their particular jurisdiction and the insurance industry.

A law firm must keep track and meet of a plethora of deadlines and procedural requirements, each independently dependant on who the clients are, what state, federal or local law applies and what insurance carrier is involved. There are many reasons why firms do not handle these requirements in an efficient manor. The level of resources and skill level of these resources is quite high in order to keep track of all the paperwork involved, especially with larger firms and the more numerous the client base.

A need exists for a firm to track and audit compliance with these numerous rules and guidelines or else suffer possible losses for their clients and even possible malpractice consequences for themselves. A system that allows a firm to track activities and audit compliance with the various rules and procedures in handling client cases would be very advantageous. This is especially true because of the nature of the legal profession. A law firm is bound by ethical considerations to keep client information confidential and a unique sensitivity to client's rights, thus the heightened need for control and accuracy of information.

### SUMMARY OF THE INVENTION

The invention disclosed in this application relates to a system and method for tracking and auditing against guidelines and compliance with these guidelines. It allows a firm to, in an automatic process, manual process or both, receive notifications of upcoming and passed guideline due dates. It has both prospective and retrospective auditing capabilities. The system is customizable to fit the idiosyncrasies of each user firm, such as client type and billing procedures. In one aspect, the present invention may utilize the industry standard Universal Task Based Management System (UTBMS) task and activity codes, but it is contemplated that other coding systems could be used. In one aspect, the system may utilize a 3^{rd} party time keeping software database package for the regular input of work time performed and various other data inputs, but it is contemplated that this could also be done within the main compliance software package itself. It also sorts and keeps track of email communications as they relate to specific tasks or matters.

The invention may be a computer-based system that may be run on an individual desktop type computer, a shared network or on a mainframe type system. The system has a user-friendly windows type menu interface. Generally, when the application is started, a “main menu” screen appears, giving the user three choices: “compliance auditing”, “exit” and “administrative functions”. It is believed that the average user will utilize the “compliance auditing” function almost exclusively to generate compliance reports and access case information as it relates to guideline compliance.

Accordingly, pursuant to one aspect of the present invention, there is contemplated a method of reporting legal matters comprising the steps of inputting into a database a rule set of predetermined requirements as to form and content of a of a legal matter; inputting actual information pertaining to the legal matter; comparing the form and content of the inputted information to the rule set; signaling a user when a difference is detected between the actual information and the rule set; optionally modifying the input information to conform with the rule set; optionally overriding the modification of the input information; and generating a report of the legal matter.

Accordingly, pursuant to another aspect of the present invention, there is contemplated a computer implemented method for tracking and auditing litigation guideline compliance for an insurance law practice, the steps comprising providing an electronic interface for a user to input: time entries, written descriptions, contact information, budgets, expenditures, emails and practice class of work completed by an attorney or employee as it relates to an insurance matter; maintaining an electronic database on at least one server that includes a software package for storing and sorting input time entries, written descriptions, contact information, budgets, expenditures, and practice class into an electronic data set; inputting at least one input time entries, written descriptions, contact information, budgets, expenditures, and practice class into the electronic database to create the electronic data set; maintaining an email database on at least one server that includes a email software package for providing email communication within and outside of the server; maintaining at least one internet connection for at least providing email communication capability; maintaining a compliance software package that communicates with the electronic database and the email database to acquire the electronic data sets and emails as input into the compliance software package; maintaining a compliance software package on the server that communicates with the email database to acquire the email data sets as input into the compliance software package; maintaining a compliance software package including at least one of: a litigation management guideline dates rule set, a ATLP rule set; a budget rule set, a report type rule set, a task description rule set and a administrative function rule set; providing an electronic interface for requesting a report from the compliance software package; communicating the electronic data set from the electronic database to the compliance software package; selecting a report type to be generated; calculating inputs and outputs based upon the report type rule set; selecting the electronic data set to audit; selecting at least one time period to audit; selecting an output type; instructing the compliance software package to begin applying the rule sets of the maintaining a compliance software package step based upon the report type selected to the selected electronic data set; generating a report base upon the report type and output type selected; and communicating the report upon the output type selected.

The invention may be further characterized by one or any combination of the features described herein, such as, further including the steps of emailing the manual audit report to a set of predetermined recipients, automatically generating reports at predetermined time intervals per the administrative rule set, including the step of listing a set of email communications associated with the report, the output type is a printed document via a computer printer or is a displayed document via a computer screen.

Accordingly, pursuant to still another aspect of the present invention, there is contemplated a computer implemented method for tracking and auditing litigation guideline compliance for an insurance law practice, the steps comprising providing an electronic interface for a user to input: time entries, written descriptions, contact information, budgets, expenditures, emails and practice class of work completed by an attorney or employee as it relates to an insurance matter; maintaining an electronic database on at least one server that includes a software package for storing and sorting input time entries, written descriptions, contact information, budgets, expenditures, and practice class into an electronic data set; inputting at least one input time entries, written descriptions, contact information, budgets, expenditures, and practice class into the electronic database to create the electronic data set; maintaining an email database on at least one server that includes a email software package for providing email communication within and outside of the server; maintaining at least one internet connection for at least providing email communication capability; maintaining a compliance software package that communicates with the electronic database and the email database to acquire the electronic data sets and emails as input into the compliance software package; maintaining a compliance software package on the server that communicates with the email database to acquire the email data sets as input into the compliance software package; maintaining a compliance software package including: a litigation management guideline dates rule set for each client, a ATLP rule set for each client; a budget rule set for each client, a report type rule set for each client, a task description rule set for each client and a administrative function rule set; providing an electronic interface for requesting a report from the compliance software package; communicating the electronic data set from the electronic database to the compliance software package; selecting a report type to be generated; selecting the client that the report relates to; calculating inputs and outputs based upon the report type rule set and the client; selecting the electronic data set to audit; entering an administrative password; editing the electronic data set within the compliance software package if required; communicating changes to the electronic data set to the electronic database; selecting at least one time period to audit; selecting an output type; instructing the compliance software package to begin applying the rule sets of the maintaining a compliance software package step based upon the report type selected to the selected electronic data set; generating a report base upon the report type and output type selected; and communicating the report upon the output type selected.

The invention may be further characterized by one or any combination of the features described herein, such as, further including the steps of emailing the manual audit report to a set of predetermined recipients, the reports are automatically generated at predetermined time intervals per the administrative rule set, and further including the step of listing a set of email communications associated with the report.

Accordingly, pursuant to still another aspect of the present invention, there is contemplated a computer implemented method for tracking and auditing litigation guideline compliance for an insurance law practice, the steps comprising providing an electronic interface for a user to input: time entries, written descriptions, contact information, budgets, expenditures, emails and practice class of work completed by an attorney or employee as it relates to an insurance matter; maintaining an electronic database on at least one server that includes a software package for storing and sorting input time entries, written descriptions, contact information, budgets, expenditures, and practice class into an electronic data set; inputting at least one input time entries, written descriptions, contact information, budgets, expenditures, and practice class into the electronic database to create the electronic data set; maintaining an email database on at least one server that includes a email software package for providing email communication within and outside of the server; maintaining at least one internet connection for at least providing email communication capability; maintaining a compliance software package that communicates with the electronic database and the email database to acquire the electronic data sets and emails as input into the compliance software package; maintaining a compliance software package on the server that communicates with the email database to acquire the email data sets as input into the compliance software package; maintaining a compliance software package including: a litigation management guideline dates rule set for each client, a ATLP rule set for each client; a budget rule set for each client, a report type rule set for each client, a task description rule set for each client and a administrative function rule set; providing an electronic interface for requesting a report from the compliance software package; communicating the electronic data set from the electronic database to the compliance software package; entering an administrative password to enter a program administration function; editing at least one of the rule sets of the maintaining a compliance software package step; exiting the program administration function; selecting a report type to be generated; selecting the client that the report relates to; calculating inputs and outputs based upon the report type rule set and the client; selecting the electronic data set to audit; entering an administrative password; editing the electronic data set within the compliance software package if required; communicating changes to the electronic data set to the electronic database; selecting at least one time period to audit; selecting an output type; instructing the compliance software package to begin applying the rule sets of the maintaining a compliance software package step based upon the report type selected to the selected electronic data set; generating a report base upon the report type and output type selected; and communicating the report upon the output type selected.

Accordingly, pursuant to still another aspect of the present invention, there is contemplated a software package for tracking and auditing litigation guideline compliance for an insurance law practice comprising a database module to store an information set of time, description and expense entries; a rule set module to store at least one rule set of predetermined time, description and expense requirements; a report module to store and produce at least one set of predetermined set of reports; a compliance module used to compare the information set from the database module to the at least one rule set and create a compliance data set; and an output module to create at least one report based upon the compliance data set and the at least one set of predetermined set of reports.

### BRIEF DESCRIPTION OF THE DRAWINGS

FIG. 1 is a exemplary flow chart of the teachings of this invention

FIG. 2 is an exemplary screen shot according to the teachings of the invention.

FIG. 3 is an exemplary screen shot according to the teachings of the invention.

FIG. 4 is an exemplary screen shot according to the teachings of the invention.

FIG. 5 is an exemplary screen shot according to the teachings of the invention.

FIG. 6 is an exemplary screen shot according to the teachings of the invention.

FIG. 7 is an exemplary screen shot according to the teachings of the invention.

FIG. 8 is an exemplary screen shot according to the teachings of the invention.

FIG. 9 is an exemplary screen shot according to the teachings of the invention.

FIG. 10 is an exemplary screen shot according to the teachings of the invention.

FIG. 11 is an exemplary screen shot according to the teachings of the invention.

FIG. 12 is an exemplary screen shot according to the teachings of the invention.

FIG. 13 is an exemplary screen shot according to the teachings of the invention.

FIG. 14 is an exemplary screen shot according to the teachings of the invention.

FIG. 15 is an exemplary screen shot according to the teachings of the invention.

FIG. 16 is an exemplary screen shot according to the teachings of the invention.

FIG. 17 is an exemplary screen shot according to the teachings of the invention.

FIG. 18 is an exemplary screen shot according to the teachings of the invention.

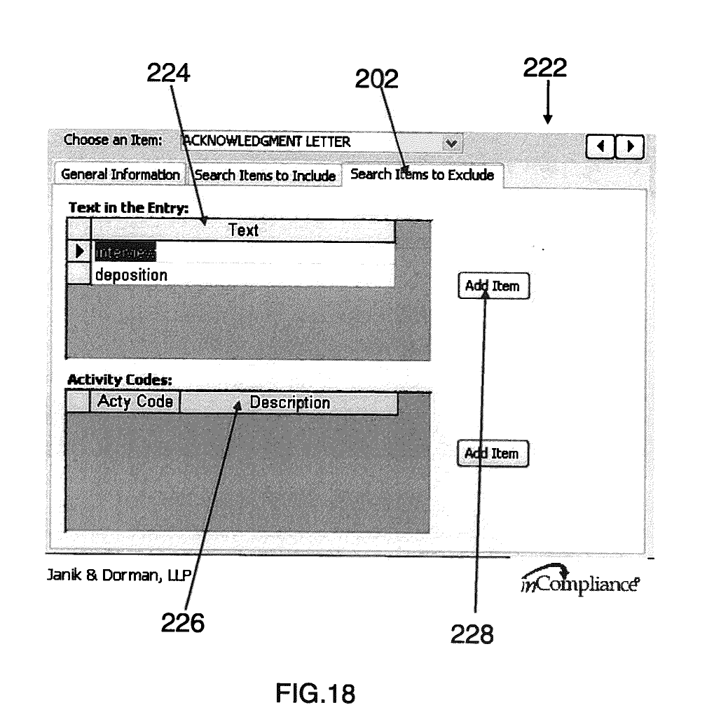

FIG. 19 is an exemplary screen shot according to the teachings of the invention.

FIG. 20 is an exemplary screen shot according to the teachings of the invention.

FIG. 21 is an exemplary screen shot according to the teachings of the invention.

FIG. 22 is an illustrative report according to the teachings of the invention.

FIG. 23 is an illustrative report according to the teachings of the invention.

FIG. 24 is an illustrative report according to the teachings of the invention.

FIG. 25 is an illustrative report according to the teachings of the invention.

FIG. 26 is an illustrative report according to the teachings of the invention.

### DETAILED DESCRIPTION

The invention encompasses a system and method relating to a guideline compliance and auditing program that allows law firm employees to know what events need to happen, in what order, what the appropriate description of the work needs to be entered and to track and audit compliance with these guidelines. The below described exemplary embodiments and exemplify adaptations of this system and method. The depiction below would enable those skilled in the art to practice the invention without undue experimentation or effort.

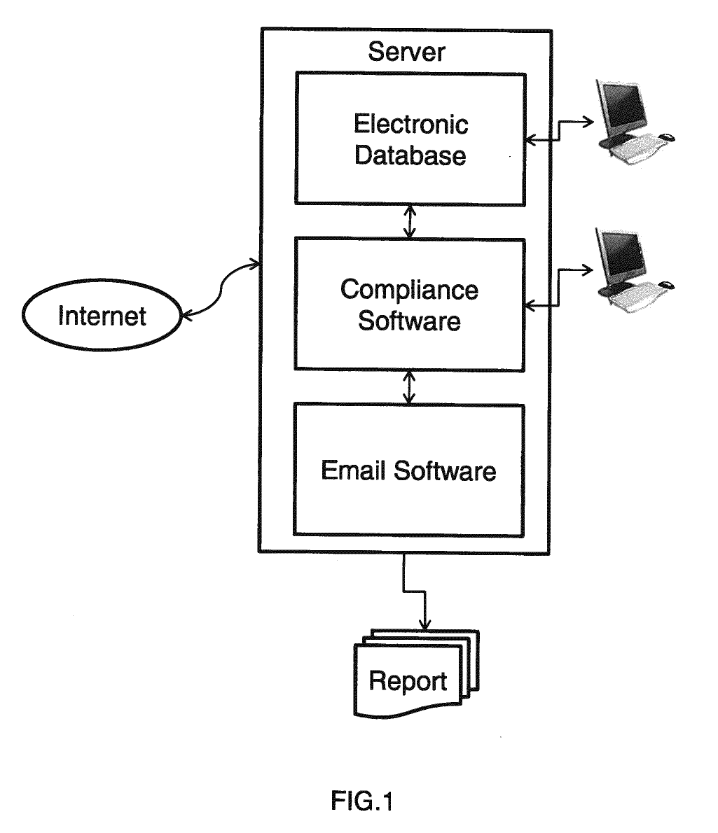

In brief overview, referring to FIG. 1, a compliance and auditing system (“system”) of the invention employs a computer software program running on a computer system, either an individual computer of some kind of networked system. The program can be accessed by users directly from the computer interface device or remotely from their individual computer if set up on a shared network. Output can be in the form of printed media, magnetic disk, CD/DVD, memory stick, or via computer display device.

The invention contemplated may include providing an electronic interface for a user to input time entries, written descriptions, contact information, budgets, expenditures, and practice class of work completed by an attorney or employee as it relates to an insurance matter via a 3^{rd} party software database or electronic database.

Maintaining the electronic database on at least one server that includes this software package for storing and sorting input time entries, written descriptions, contact information, budgets, expenditures, and practice class into an electronic data set.

Users inputting at least one input time entries, written descriptions, contact information, budgets, expenditures, and practice class into the electronic database to create the electronic data set.

Maintaining an email database on at least one server that includes a email software package for providing email communication within and outside of the server and maintaining at least one internet connection for at least providing email communication capability.

Maintaining the compliance software package (e.g. the compliance and auditing program) on the server, where the 3^{rd} party software database and the compliance software package communicate with each other to exchange relevant data.

Maintaining the compliance software package to include a of litigation management guideline dates rule set (exemplified in Table 1, below), a ATLP rule set; a budget rule set, a report type rule set, a task description rule set (exemplified in Table 2, below) and a administrative function rule set.

Providing an electronic interface for requesting reports and performing administrative functions, detailed below, from the compliance software package as well as an interface for communicating the resultant reports. Additionally, the compliance reports can be set up to be automatically generated at specified intervals.

TABLE 1

| | | | Days | Days | |
|---|---|---|---|---|---|
| LMG Item | Period | Flule Type | Due | Type | Date Trigger |
| INITIAL ATLP/BUDGET SUBMITTED | Initial | Coverage Litigation | 4 | Business | File assignment date |
| ACKNOWLEDGMENT LETTER | Initial | Litigation | 1 | Calendar | File assignment date |
| ACKNOWLEDGMENT LETTER | Initial | Coverage Analysis | 1 | Calendar | File assignment date |
| ACKNOWLEDGMENT LETTER | Initial | Coverage Litigation | 1 | Calendar | File assignment date |
| INTERNAL AUDIT | Initial | Litigation | 90 | Calendar | File assignment date |
| INTERNAL AUDIT | S | Litigation | 90 | Calendar | ATLP Period begin data |
| INTERNAL AUDIT | Initial | Coverage Litigation | 90 | Calendar | File assignment date |
| INTERNAL AUDIT | S | Coverage Litigation | 90 | Calendar | ATLP Period begin date |
| INITIAL ATLP PLANNING CONFERENCE | Initial | Litigation | 14 | Calendar | File assignment date |
| INITIAL ATLP PLANNING CONFERENCE | Initial | Coverage Litigation | 14 | Calendar | File assignment date |
| COST ESTIMATE | Initial | Coverage Analysis | 1 | Business | File assignment date |
| COST ESTIMATE | Initial | Coverage Litigation | 1 | Business | File assignment date |
| COVERAGE ANALYSIS | Initial | Coverage Analysis | 9 | Business | File assignment date |
| COVERAGE ANALYSIS | Initial | Coverage Litigation | 9 | Business | File assignment date |
| NEXT ATLP PLANNING CONFERENCE | Initial | Litigation | 105 | Calendar | File assignment date |
| NEXT ATLP PLANNING CONFERENCE | Initial | Coverage Litigation | 105 | Calendar | File assignment date |
| NEXT ATLP PLANNING CONFERENCE | S | Litigation | 105 | Calendar | ATLP Period begin date |
| NEXT ATLP PLANNING CONFERENCE | S | Coverage Litigation | 105 | Calendar | ATLP Period begin date |
| NEXT ATLP/BUDGET | Initial | Litigation | 119 | Calendar | File assignment date |
| NEXT ATLP/BUDGET | Initial | Coverage Litigation | 119 | Calendar | File assignment date |
| NEXT ATLP/BUDGET | S | Litigation | 119 | Calendar | ATLP Period begin date |
| NEXT ATLP/BUDGET | S | Coverage Litigation | 119 | Calendar | ATLP Period begin date |
| INITIAL ATLP/BUDGET SUBMITTED | Initial | Litigation | 4 | Business | File assignment date |
| PRETRIAL REPORT | Any | All | −120 | Calendar | Trial date |
| PRE-DEPOSITION CONFERENCE | Any | All | −5 | Business | Deposition date |
| DEPOSITION REPORT | Any | All | 10 | Business | Deposition date |

TABLE 2

| | | | | | Juris Time |
|---|---|---|---|---|---|
| | | Actvity | Text to | Juris UDF | Entry Note |
| LMG Item | Text to Include | Code | Exclude | Code | Required |
| ATLP/BUDGET SUBMITTED | agreed-to litigation plan | A106 | draft | 101 | NO |
| | agreed to litigation plan | | | | |
| | issued | | | | |
| | atlp | | | | |
| ACKNOWLEDGEMENT LETTER | acknowledging assignment | A106 | interview | 102 | NO |
| | acknowledging matter | | | | |
| | acknowledged | | | | |
| | acknowledge | | | | |
| INTERNAL AUDIT | file audit | | | 103 | NO |
| | compliance audit | | | | |
| | audit | | | | |
| | internal audit | | | | |
| INITIAL ATLP PLANNING CONFERENCE | agreed-to litigation plan | A106 | draft | 104 | NO |
| | agreed to litigation plan | | submitted | | |
| | planning conference | | | | |
| | atlp | | | | |
| COST ESTIMATE | estimate of costs | A106 | deposition | 105 | NO |
| | estimate of cost | | | | |
| | cost estimate | | | | |
| COVERAGE ANALYSIS | coverage analysis | A106 | draft | 106 | NO |
| | | | discuss | | |
| NEXT ATLP PLANNING CONFERENCE | agreed-to litigation plan | A106 | | 107 | NO |
| | agreed to litigation plan | | | | |
| | planning conference | | | | |
| | atlp | | | | |
| NEXT ATLP/BUDGET | agreed-to litigation plan | A106 | draft | 108 | NO |
| | agreed to litigation plan | | | | |
| | atlp | | | | |
| | budget | | | | |
| ISSUE J&D COMPLIANCE LETTER | guideline compliance | A106 | | 109 | NO |
| | letter of compliance | | | | |
| | compliance letter | | | | |
| ATLP/BUDGET SUBMITTED | issued | A106 | draft | 110 | NO |
| | agreed-to litigation plan | | | | |
| | agreed to litigation plan | | | | |
| | atlp | | | | |
| DEPOSITION REPORT | deposition | A109 | draft | 111 | YES, Deponent Last Name |
| | deposition report | | | | |
| DEPOSITION | deposition | A109 | settlement | 112 | YES, Deponent Last Name |
| | | | trial | | |
| | | | arbitration | | |
| TRIAL | trial | A109 | settlement | 113 | NO |
| | | | arbitration | | |
| | | | deposition | | |
| SETTLEMENT CONFERENCE | conference | A109 | | 114 | NO |
| | settlement | | | | |
| MEDIATION | mediation | A109 | deposition | 115 | NO |
| | | | trial | | |
| ARBITRATION | arbitration | A109 | settlement | 116 | NO |
| | | | trial | | |
| | | | deposition | | |
| EXPERT WITNESS | expert witness | | | 117 | NO |
| | witness | | | | |
| | expert | | | | |
| | defense witness | | | | |
| SETTLEMENT AUTHORITY | settlement | A106 | | 118 | NO |
| | authority | | | | |

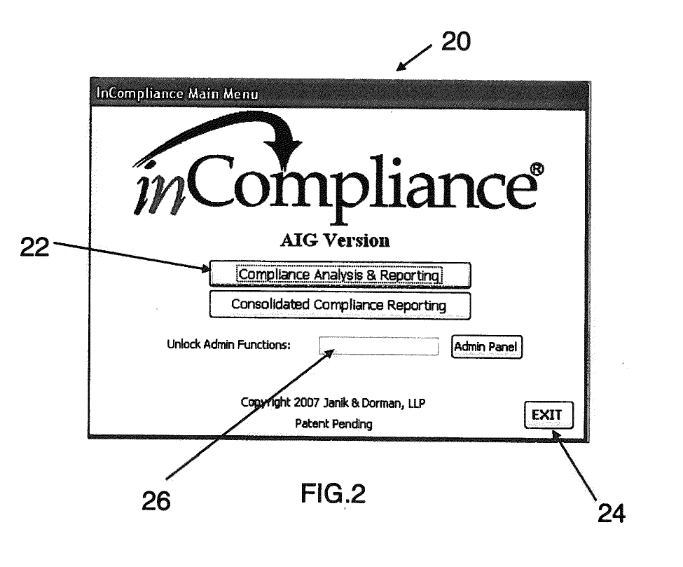

Referring to FIG. 2, a user enters the computer application and is presented with a main menu screen 20. The system is arranged is a series of nested menus, from which users can access all the functionality of the system. From this introductory screen or main menu screen 20, the user is presented with three choices or paths to follow to access the system:

### 1: Open Compliance Maintenance Form 22;

### 2: Administrative Functions 26; and

### 3: EXIT 24.

From these choices, the user clicks on the desired function. In the following sections, both the Compliance Maintenance Form 22 and the Administrative Functions 22 will be detailed.

### 1: Compliance Maintenance 22

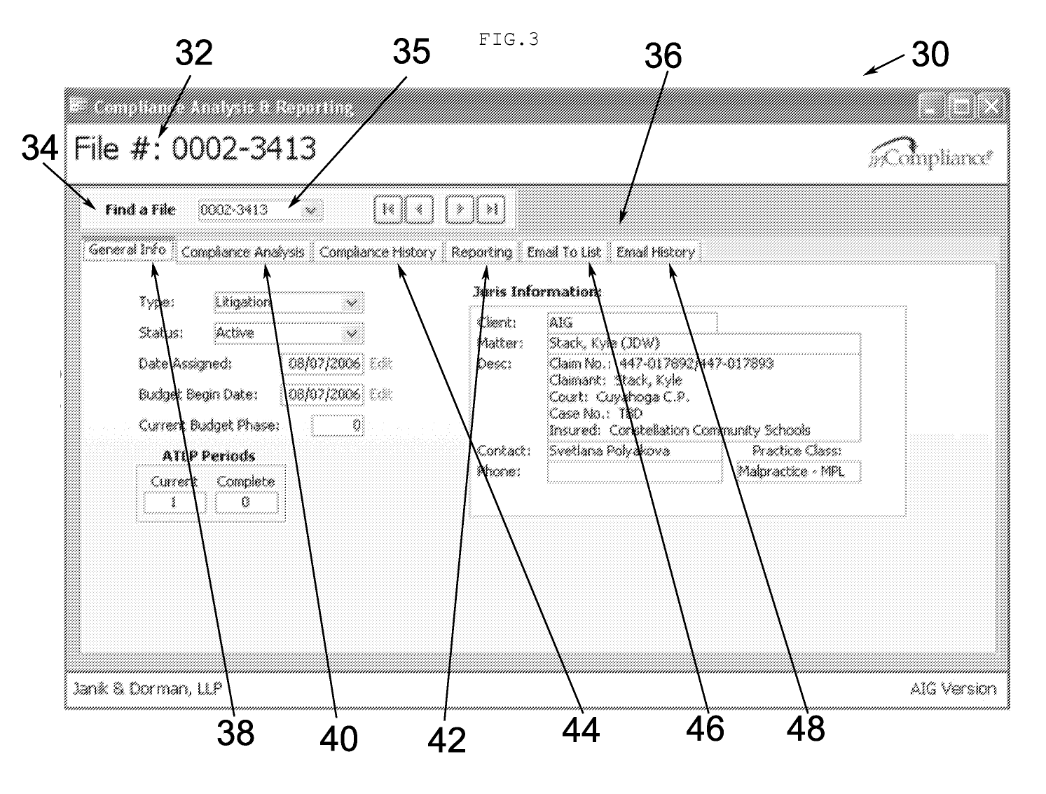

Looking first at Open Compliance Maintenance Form 22 choice. This menu choice will take the user to the Compliance Analysis & Reporting screen 30, see FIG. 3. This screen contains the Header Information section 32, the File Location section 34, and the Information Tabs section 36. Each is described below.

The Header Information section 32, displays the file currently selected. Whichever file number is shown in the header is what case information is displayed in the Information Tabs section 36. When selecting a file for audit or reporting, it is critical that this section is checked prior to performing the associated functions to make sure that the user is accessing the desired records.

The File Location section 34, allows the user to find specific files, or browse through all files one-by-one. The box named “Find a File” 35 is a drop-down list populated with every file contained in the guideline compliance and auditing program. It is necessary to remember that this list does not automatically contain every file on which the firm is performing work, only those that have been entered into the particular client criteria. The client criteria are a group of rules that apply to the displayed client and used by the system to determine compliance. Only those files that meet the client criteria (in FIG. 3 for example, AIG) will be found in this drop-down box. The user can either click the down arrow to scroll through files, or may type the file number directly and press <ENTER>.

The Information Tabs section 36, displays all of the information related to the selected file and are separated into five different tabs or screens. Each of the five tabs contains various information fields and system functions. The Information Tab section 36 is also the location where users come to perform a manual audit, as well a print all reports contained in the guideline compliance and auditing program. Tabs headings generally describe the information contained therein. Tab headings currently include the following: General Information 38, Compliance Analysis 40, Reporting 42, Compliance History 44, Email History 46, and Email To List 48. Each tab section described in more detail below.

### Compliance Maintenance—Information Tabs

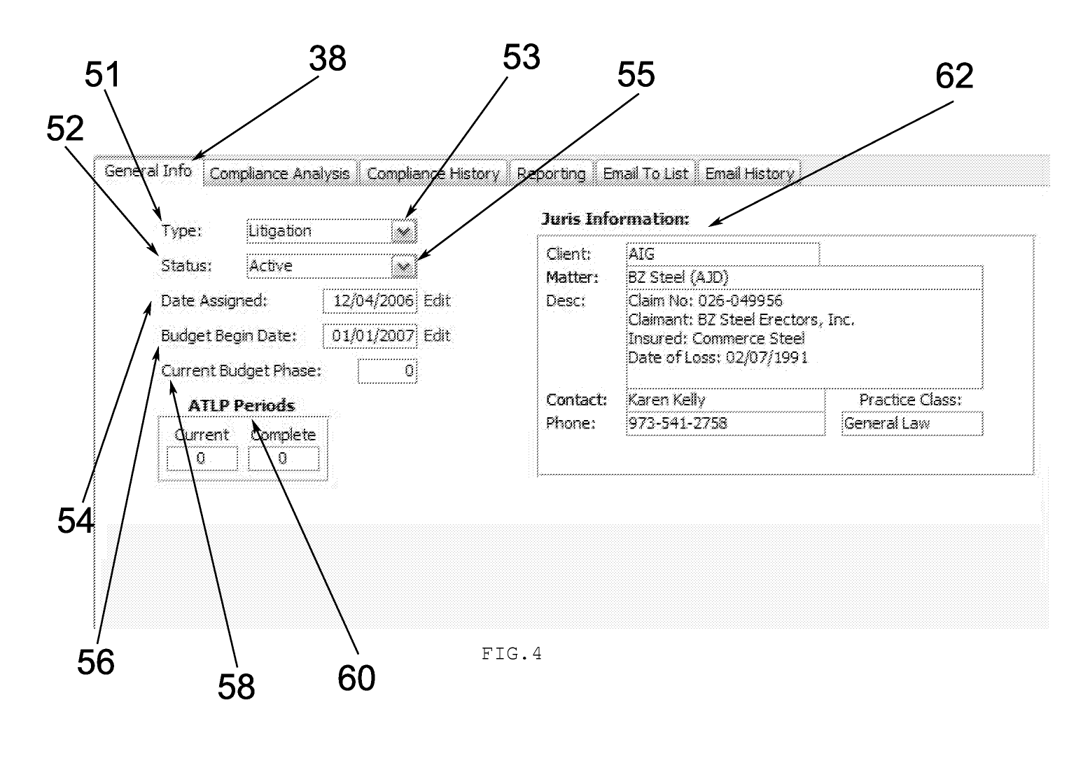

The first tab, in the Information Tab section 36, is the General Information tab 38, see FIG. 4, as the heading suggests, this tab contains general information for the particular file selected. It contains seven main fields of information. They are detailed below:

1: File Type 51: The guideline compliance and auditing program uses the File Type 51 in order to add the appropriate litigation management guideline dates. The choices are: Litigation 53, Coverage Analysis (not shown) and Coverage Litigation (not shown). As the client specific litigation management guidelines (LMG) spell out different dates depending on the type of file, it is extremely important that this field be set correctly. A drop-down the list of the choices is provided and the user selects the appropriate file type 51.

2: File Status 52: This field sets the status of the file shown. The choices are: Active 55 (shown), Closed, Narrative, Nominal, Suspended, and Waived. Active—file is currently open and the file is of a type that falls under the client's Litigation Management Guidelines. Closed—file is not currently being worked. Narrative—this is a file which is of a size and scope which make full reporting to the client inappropriate; narrative reporting excludes of the rigorous reporting required under LMG. Nominal—Similar to narrative, with slightly more reporting. Suspended—a file which has previously been under LMG guidelines, but which the client has temporarily removed the reporting requirements; this is still an active file. Waived—this is a file, just assigned to the firm, which the client has decided not to place under LMG guidelines at all; no reporting is required. A drop-down the list of the choices is provided and the user selects the appropriate file status 52. It is important to note that the guideline compliance and auditing program will only perform audit functions when the status is set to Active 55. Any other statuses will cause the system to skip the file during its prospective audit processes. The other statuses are provided for firm information only.

3: Assignment Date 54: This field displays the date that the file was assigned to the firm. This information is pulled directly from the 3^{rd} party database software and cannot be edited.

4: Budget Begin Date 56: This field displays, for new files, the date the first budget period begins. The budget period runs contemporaneous with the ATLP reporting guidelines spelled out by the client. For example, a client may require that a formal file report be furnished aver 120 days during the life of the file. The budget period would run over these same dates, as the file must be budgeted for under the same 120-day period. This field is imported from the 3^{rd} party database software and cannot be edited within the system.

5: Budget Phase 58: This field indicates the file's current budget phase number. The budget phase is simply the number related to the budget period (i.e.—the first budget period would be budget phase 0, the second would be 1, and so on) It is merely an easy way to refer to the number of reporting periods in the life of the file. This will be different than the Current ATLP Period (see below) for all files who do not have budgets entered into the 3^{rd} party database software for all historical ATLP periods. This field cannot be edited.

6: ATLP Periods 60: This field shows both the current ATLP period number, and how many ATLP periods have been completed. ATLP is an acronym for “Agreed To Litigation Plan” and is a predetermined set of time periods in a litigation matter corresponding to events that are agreed to happen in the respective period. These fields cannot be edited.

7: Juris Information 62: This field shows client information, Matter name, Description of the Matter, Contact information and Practice Class. Practice classes are categorizations used by law firms to segregate files of similar types together, For example, a law firm could have a practice class for Medical Malpractice or Casualty or Liability.). This box also contains some general file information, which is pulled directly from the 3^{rd} party database software, or electronic database. The information contained cannot be edited. However, it is live data, so that any changes made in the 3^{rd} party database software will be immediately visible here. This data will print on each and every report header.

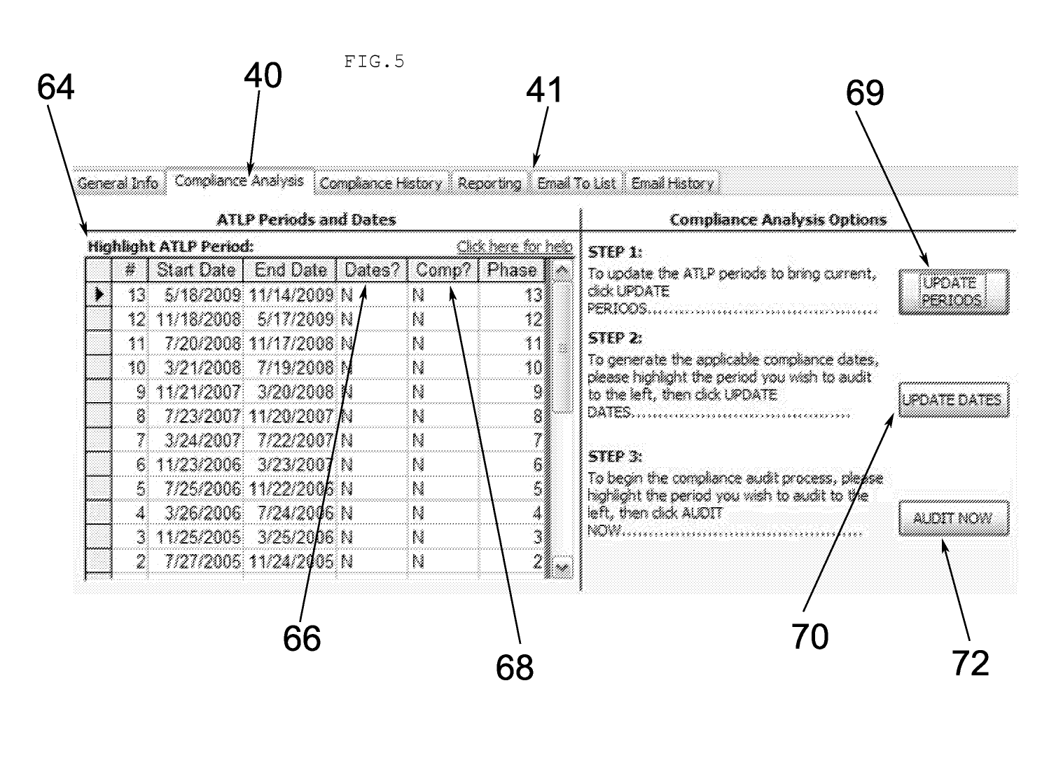

The next tab, in the Information Tab section 36, is the Compliance Analysis tab 40, see FIG. 5, show a three step process, with a clickable button, and the ATLP Periods List 64. The ATLP list and steps are detailed below:

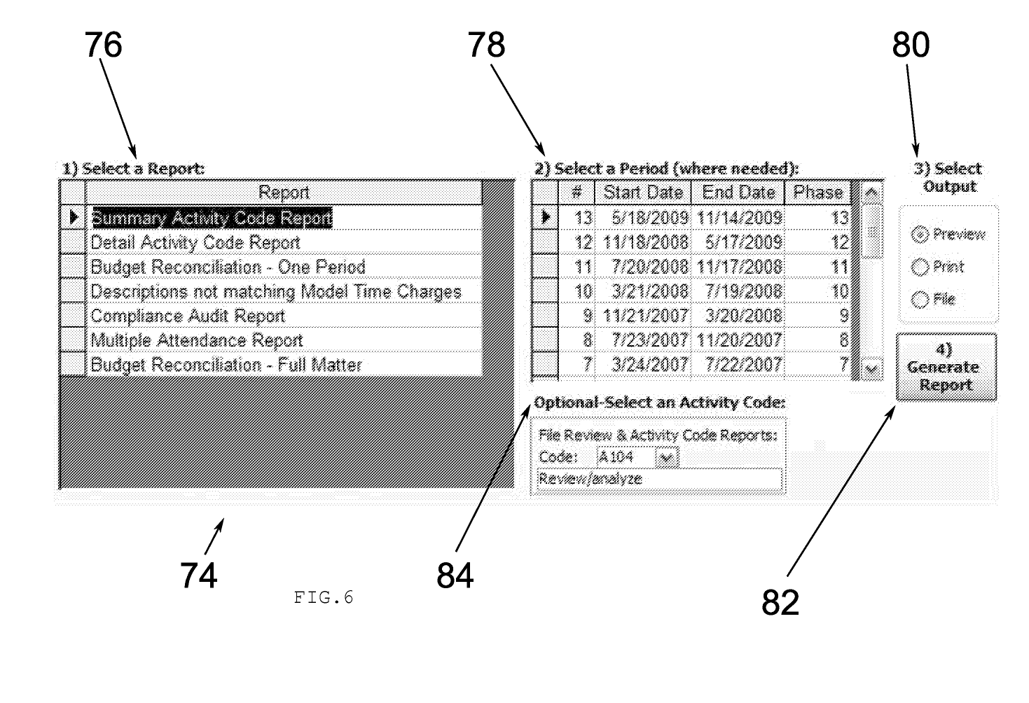

ATLP Periods List 64, see FIG. 6: This section details each ATLP period in the life of the file. It shows the period number, beginning and ending dates of each period, whether litigation management guideline dates have been generated, which periods have been completely audited, and the budget phase number for each period.

If the “Dates?” column 66 displays a “Y”, then all litigation management guideline dates have been generated for this file and the selected period. If an “N” is present, then further action is necessary before performing an audit on this period. If the “Comp?” column 68 contains a “Y”, this indicates that the compliance audit has been marked as complete for this period, and no further auditing may be performed.

Step 1 69: This button will bring the ATLP periods list up to date. The use of this button will be discussed in the section named “Performing a Manual Audit”.

Step 2 70: This button will update the selected period with all applicable litigation management guideline dates. The use of this button will be discussed in the section named “Performing a Manual Audit”.

Step 3 72: This button will open the “Compliance Item Identification” form. The use of this button will be discussed in the section named “Performing a Manual Audit”.

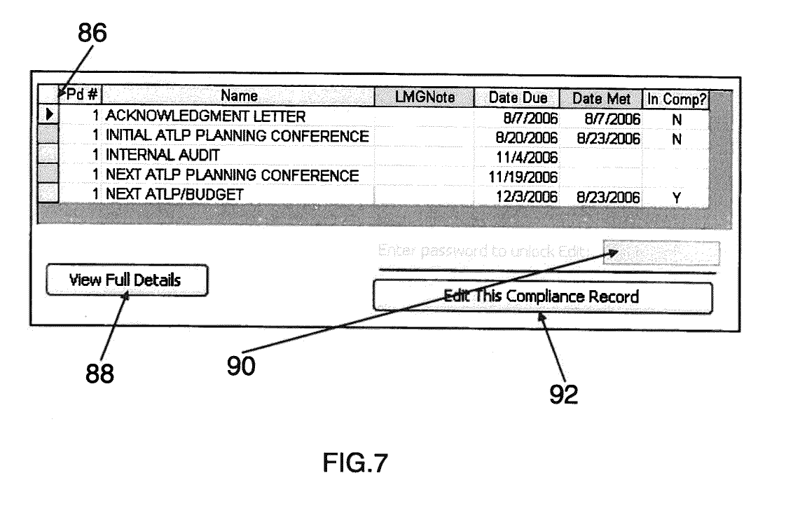

The next tab, in the Information Tab section 36, is the Reporting tab 42, see FIG. 7, show a four-step process on this screen where users will generate most reports contained in the guideline compliance and auditing program. To generate a report(s), users follow the 4-step process from the selectable windows on the Reporting screen 74:

1) Select a report 76
2) Select a period 78
3) Select an output type 80
4) Generate the report 82
Each of these steps is described below:

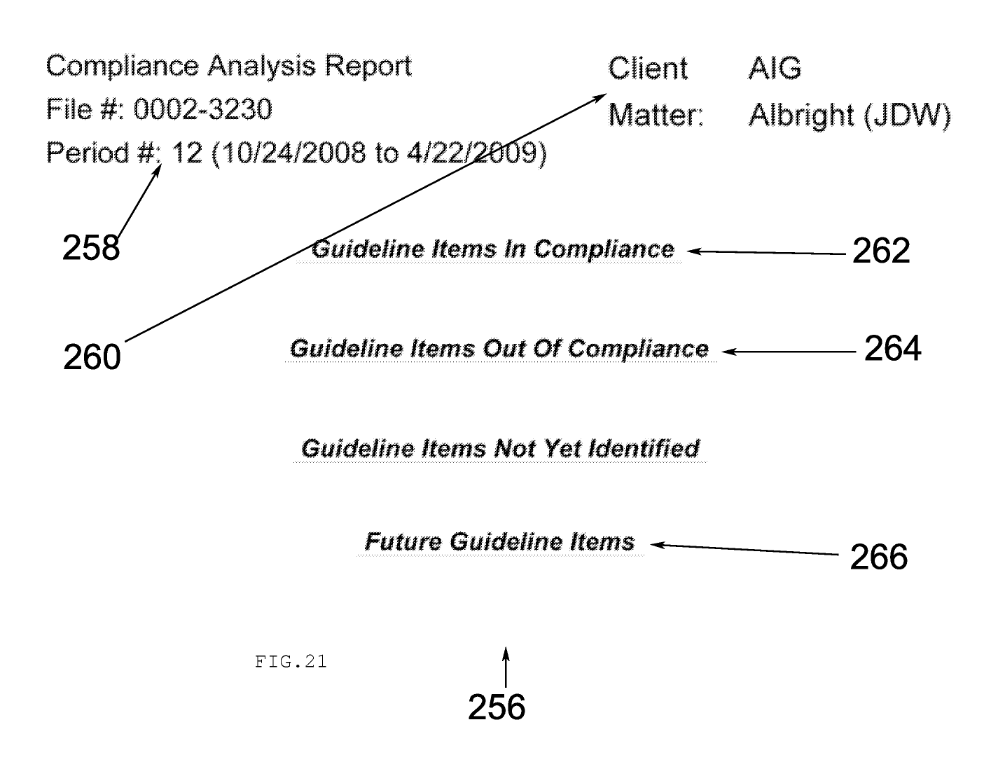

Step one; Select a Report 76, this figure contains a list of all reports available in the default installation of the guideline compliance and auditing program. The default list includes standard reports, such as: summary activity report, detail activity code report, budget reconciliation-one period, descriptions not matching model time charges, compliance audit report, multiple attendance report, and budget reconciliation-full matter. Illustrative examples of some of these reports are shown later (see FIGS. 21-25). Optionally, user-generated reports can be added to this list as well, providing immediate access by all users. Select Activity Code box 84 has a drop down type selection for a user to select from the UTBMS activity codes to limit the given report to that code only.

Step two; Select a Period 78, this box shows all ATLP periods for the matter shown in the report header. It includes the period begin and end dates, as well as the associated budget phase for each period.

Step three; Select an Output Type 80, the guideline compliance and auditing program optionally allows three different output formats, selected by clickable buttons. They include: Preview, where the report will be printed to the screen; Print, where the report will be sent directly to the user's printer; and File, where the report can be exported and saved, or attached to an email.

Step four; Generate the Report 82, clicking on this button will generate the report based upon the criteria selected in the three proceeding steps.

The next tab in the Information Tab section 36 is the Compliance History tab 44 contains a list of al the litigation management guideline dates currently contained in the system for the file previously selected. The main window, the Litigation Management Guideline Item List 86 (generally shown as: LMG), contains the following informational fields: Pd #—This is the ATLP period number for the item; Name—The name of the litigation management guideline item; Date Due—The system-calculated due date for the litigation management guideline item; Date Met—This field shows the date the litigation management guideline item was satisfied. If no date exists, the item has not been identified; and, In Comp?—This field shows a ‘Y’ or an ‘N’, indicating whether the item was achieved in a timely fashion.

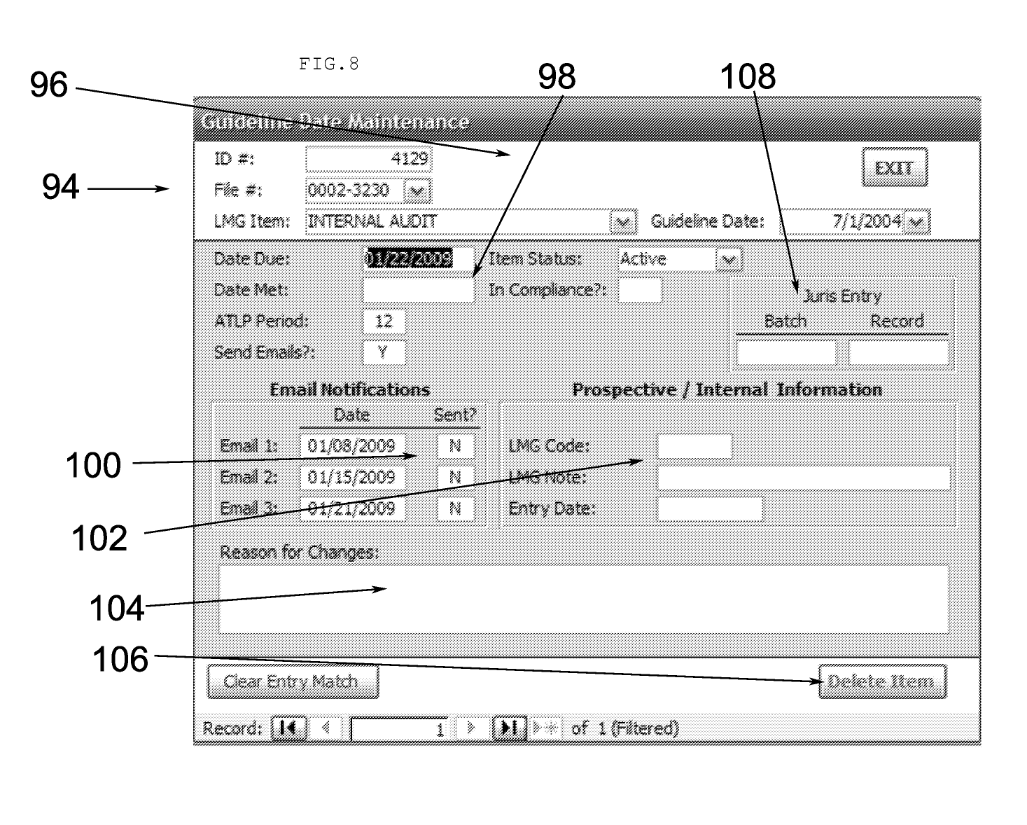

A clickable button, view full details button 88, in also included in the compliance history tab window. Clicking the view full details button 88 will show all of the details that make up the item selected in the list above by opening the Guideline Date Maintenance form 94, see FIG. 8. Note that this form will be open in read-only mode when opening with this button. In order to edit the record, a user must first enter the system administrator password in the password box 90 to the left, and then click on the Edit This Compliance Record button 92.

The Guideline Date Maintenance form 94, serves two purposes. First, it allows all users of the system to view all details of the litigation management guideline items. In this case, the form will be opened in read-only mode and no changes may be made. However, when the form is opened by using the system administrator password, some of the data on this form becomes editable by the user. For each item described below, an indication will be made if the field is editable by the administrator.

Header information section 96 contains general information about the LGM item, such as the file, litigation management guideline name, applicable guideline date, and the litigation management guideline item ID. The information in this section is not editable.

Litigation Management Guideline (LMG) Date Information section 98. This area details out the Date Due and Date Met, as well as the In Compliance field (showing if the item is in compliance with the litigation management guideline) and Send Notifications fields. These fields may be edited by the system administrator. The ATLP period field cannot be edited.

The Send Notification field (which will contain a ‘Y’ or ‘N’) is used to instruct the system whether or not to send email notifications for the item displayed. A ‘Y’ will allow emails to be sent, while an ‘N’ will preclude notification.

There are many reasons why the Date Due, Date Met and In Compliance fields would be edited. One example comes in extensions of due dates. Using the example of the due date for submission of the ATLP and Budget, which for this purpose will be due on October 1st. The system will assign the due date for this item for October 1, and will set up a litigation management guideline item in the system. However, assume that the claims professional agrees to extend the due date to October 5th. Let's also assume that the ATLP and Budget were submitted on October 5th.

The system will find the submission of the ATLP/Budget on October 5th, and will indicate that on this litigation management guideline item entry by placing October 5 in the Date Met field. Remember, however, that the system shows the Date Due as October 1. Therefore, the system will mark the item as out of compliance by placing an ‘N’ in the In Compliance field.

Using this edit form, the system administrator (or compliance officer) could change the Date Due to October 5 and mark the item as in compliance. They can then add a description in the Reason for Changes box detailing what had transpired. For example: “Pursuant to email from <claims professional> on October 2, the due date for the initial ATLP/Budget was extended to October 5.”

Notification information section 100 shows the date's emails have been generated by the system. The system sends out email notifications each time the system runs its batch update, preferably every evening, for all litigation management guideline items in the system which have not been satisfied (entries with no Date Met value). This data is fully editable when the form is opened by using the administrative password.

When the system identifies a prospective item, the Prospective Information section 102 will contain data pulled from that entry. This section will be covered in greater detail below, in the performing a manual audit section. The data shown here is read-only and not editable from this form.

The Change Information section 104 is a free-text entry box that may be used to store any notes, for example, notes related to the displayed litigation management guideline item. This is editable only if the Guideline Date Maintenance form 94 is entered by using the administrative password.

The Delete Record button 106 allows a user to permanently delete the displayed litigation management guideline item. This button is only active if the Guideline Date Maintenance form 94 is entered by using the administrative password.

The Juris Entry Information section 108 will display the batch # and record # of the associated entry in the 3^{rd} party software package if the litigation management guideline item has been satisfied. These fields are generally not editable from this form.

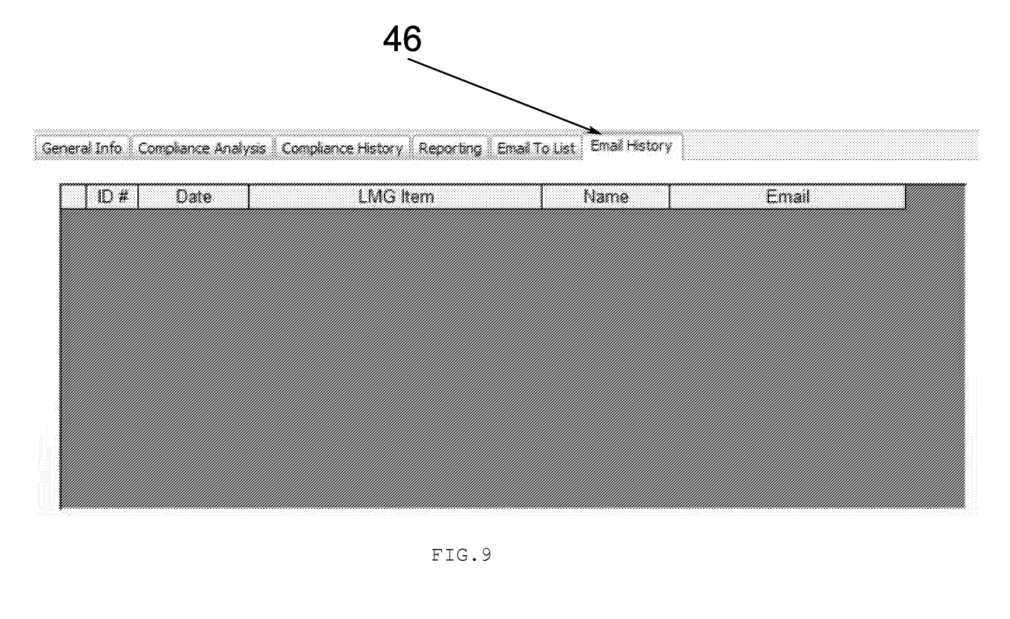

The next tab in the Information Tab section 36, is the Email History tab 46, see FIG. 9, this displays a record of all email notifications sent on a particular matter. It shows the litigation management guideline Date ID #, the notification Date, the name of the litigation management guideline Item, the recipient Name and the recipient Email address. This provides a snapshot of all email activity generated by the system on a selected matter.

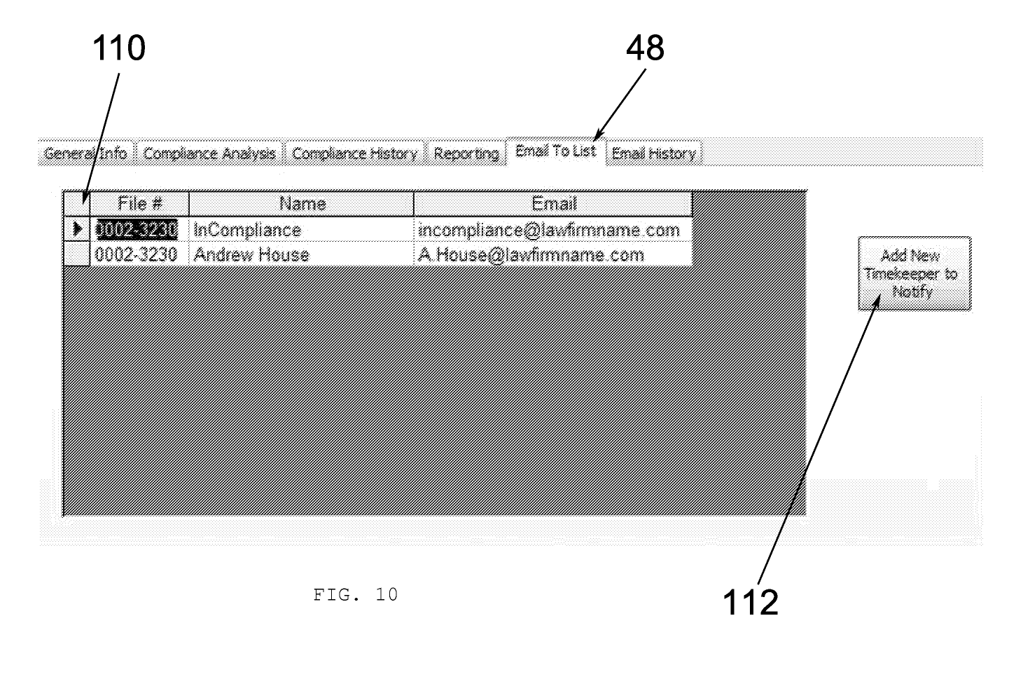

The final tab in the Information Tab section 36, is the Email To List tab 48, see FIG. 10, displays a list of all individuals who will receive notifications (generally, nightly emails) for system items on the file. The list may contain people both inside and outside the firm. The individuals are maintained by use of the User Maintenance screen, which can be found by clicking here. Within the email to list tab window is a notification list section 110, which lists all of the active notification recipients for the file number displayed.

It also contains an Add Notification button 112. Click this button to add a new person to be notified on this matter. This button will bring up a drop-down list with all current system users. System users are edited by using the User Maintenance screen here. In addition to entry of people here, there is a Notification Maintenance screen which allows for many more options, such as deleting or changing notifications, than can be performed here.

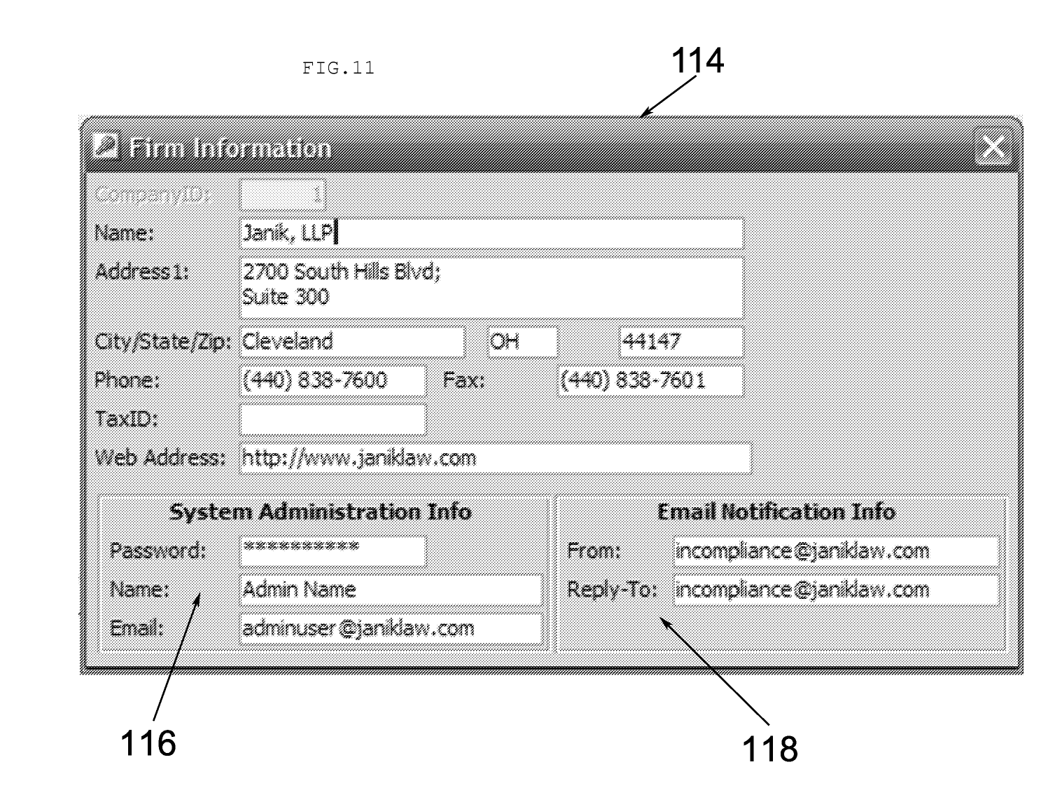

Another administrator editable form/window contains some of the pertinent contact information concerning the firm utilizing the system. Generally, any edits to this form will propagate through out the system immediately. This is the Firm Information form 114, see FIG. 11. This form allows the administrator to enter and edit the firm information (e.g. firm name, firm address, phone number, web address, tax ID). There is a section where the administrator information 116 is entered, including the set-up of the administrator password. This password is required to perform any administrative functions to the system. Additionally, a notification section 118 is also included on the Firm Information form 114 where the firm will enter into the “FROM” field the firm mailbox name that will be generating the nightly notification emails. The “REPLY-TO” field is options, and can contain any email valid email address. The address in the “REPLY-TO” field will be used if an end-user attempts to reply to a nightly notification email.

Two features of the system are the ability to perform audits of the user's compliance with litigation management guidelines. To accomplish this goal, the system provides two methods for auditing—manual (retrospective) and automated (retrospective and prospective). This next section will focus on the steps required to perform a manual audit of a file with the system.

### Compliance Maintenance—the Manual Audit

The manual audit function of the system may be used to audit any ATLP period in the life of a file, including its most current. A user will select the file they wish to audit, then select the period. After that, they will use the Compliance Item Identification screen 30 to search for entries or electronic data sets in the 3^{rd} party software package which meet each guideline item.

As an illustrative example of a manual audit, begin by, opening the Compliance Analysis & Reporting screen 30 from the main menu 20. Once open, use the Find a File box 34 to search for and find the matter you wish to audit. The next step is to verify the general information for the file (e.g. header information 32, file type 51, file status 52, and juris information 62). Once the user has verified that they have the correct, then click on the compliance analysis tab 40 to continue to the audit.

The manual audit is a four-step process detailed below.

Step one: From the Compliance Analysis screen 41, first, click on the row in the ATLP Period list 64 which contains the period you wish to audit. In the case of this example, there is only one period to audit. The right-pointing arrow will sit next to the row selected from the list.

Step two: From the Compliance Analysis screen 41, secondly, click the update periods button 69 to ensure that the ATLP Period list 64 is up-to-date. If no update is necessary, the program will give a message stating that fact.

The system updates periods by looking at the most recent ATLP period. If the end date for this period falls after the current system date, no update is necessary as the current date falls within an ATLP period. If the current date falls after the end date of the most recent ATLP period and new ATLP period will be calculated and added to the table. This process will also be performed automatically each evening as part of the nightly procedures, covered later.

Step three: From the Compliance Analysis screen 41, thirdly, click the Update Dates button 70. This function will populate the database with the appropriate litigation management guideline dates for this file for the period selected. The system will use the file type (on the General Information tab 38) to determine which litigation management guideline items to include. This is why it is important that the file type 51 is accurate.

Step four: Again, from the Compliance Analysis screen 41, click on the Audit Now button 72 and the manual audit will take place. A Compliance Item Identification screen 120 will open up with the results of the audit and this screen will be used for manually auditing a file, and is where guideline dates will be matched with appropriate 3^{rd} party software time entries.

There are three main components of the manual audit process. The Compliance Item Identification, the Multiple Occurrence Identification Form and the View All Time Entries. Each is detailed below.

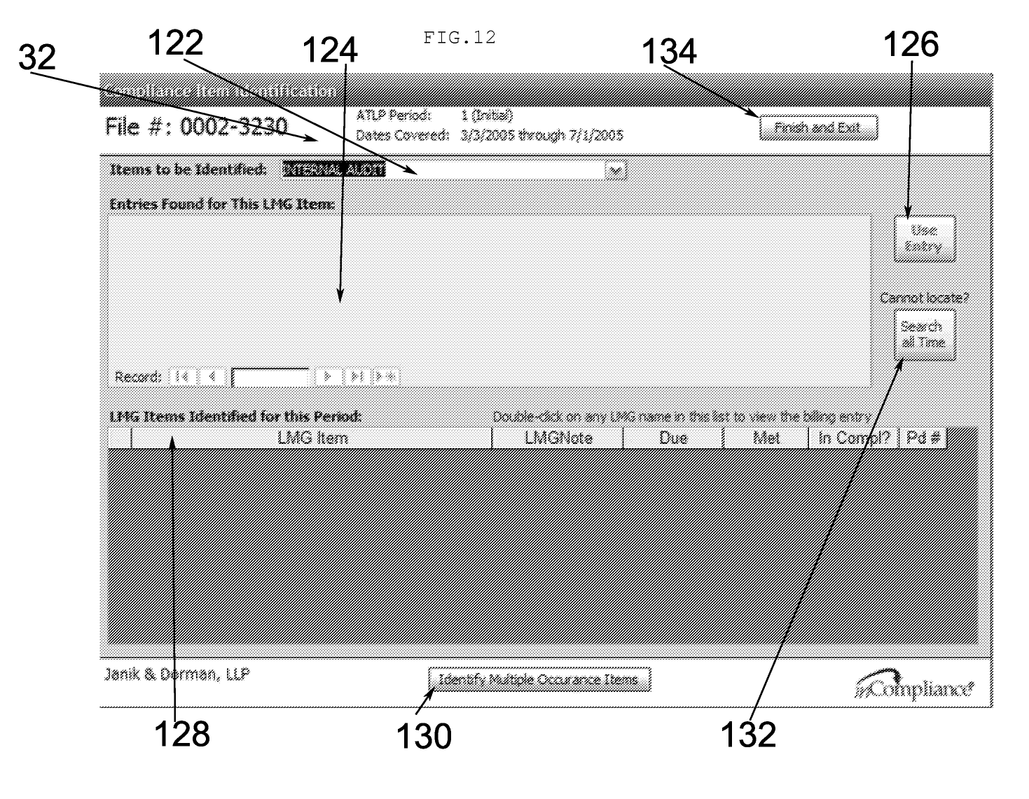

First, an illustrative example of the Compliance Item Identification 120, see FIG. 12.

On the Compliance Item Identification screen 120, there are eight fields or buttons that are utilized in the audit. They are as follows:

The Header 32 displays the current file selected, as well as the ATLP period being audited and the beginning and ending dates for that period.

The Litigation Management Guideline (LMG) Item List 122, as you can see from this figure, this drop-down list contains the litigation management guideline items that need to be identified for this period and file. It will only show items that have NOT been identified. As items are satisfied by finding appropriate time entries, that item will be removed from this list.

When an item is selected, the box below labeled ‘Entries Found for This litigation management guideline Item” will display entries located which may satisfy this item. For example, we'll select the first item on the list, Acknowledgment Letter. The system attempts to identify entries, and presents the following information:

The Entries Found 124 box will display all of the 3^{rd} party software time entries that the system feels may satisfy the litigation management guideline item selected in the drop-down list above. In our example, we can see from the record selector at the bottom of this section that the system has identified only one entry, which it feels meets the Acknowledgment Letter item. You can see the total number of records found by the Record box, which also allows the user to scroll through all entries located in the event multiples are found.

In this example, we can see that this entry does indeed satisfy the litigation management guideline item for Acknowledgment Letter. Once an entry is found, proceed to the next step, the Use Entry button 126.

Once an entry is found, the user simply clicks the Use Entry button 126. When the Use Entry button is clicked, the system will kink the guideline item with the entry located. In this way, the system can determine if the guideline item's due date has been met, based on the time entry date. This link is stored in the database so that reports can show the detail of both the guideline item and the entry which satisfied that item.

Items Identified 128, this box simply shows all of the guideline items, for the applicable file and time period, which have already been identified. Once they appear in this list, the user knows that no further identification is necessary.

Click on the Multiple Occurrences 130 to identify events (such as Depositions), which may occur more than one time in any individual ATLP period. This will open the Multiple Occurrence Identification screen, found here.

If the system finds no associated time entries, or does not show an entry that meets the guideline item, the user may click the all time button 132 to show all time entries on this file for the associated time period. In this way, the user may find entries, which were not coded or worded correctly.

Click the Exit button 134 to exit the form, and you will be presented with this choice. Selecting “YES” will lock out anyone else from performing a manual audit on this file for this ATLP period. The system will continue to perform any automated batch processing on the file. Selecting “NO” will leave the period open for further audit, and similarly the system will continue the batch audit process on the file. Select “YES” here if you are sure there are no further compliance items to identify for this file for the selected period.

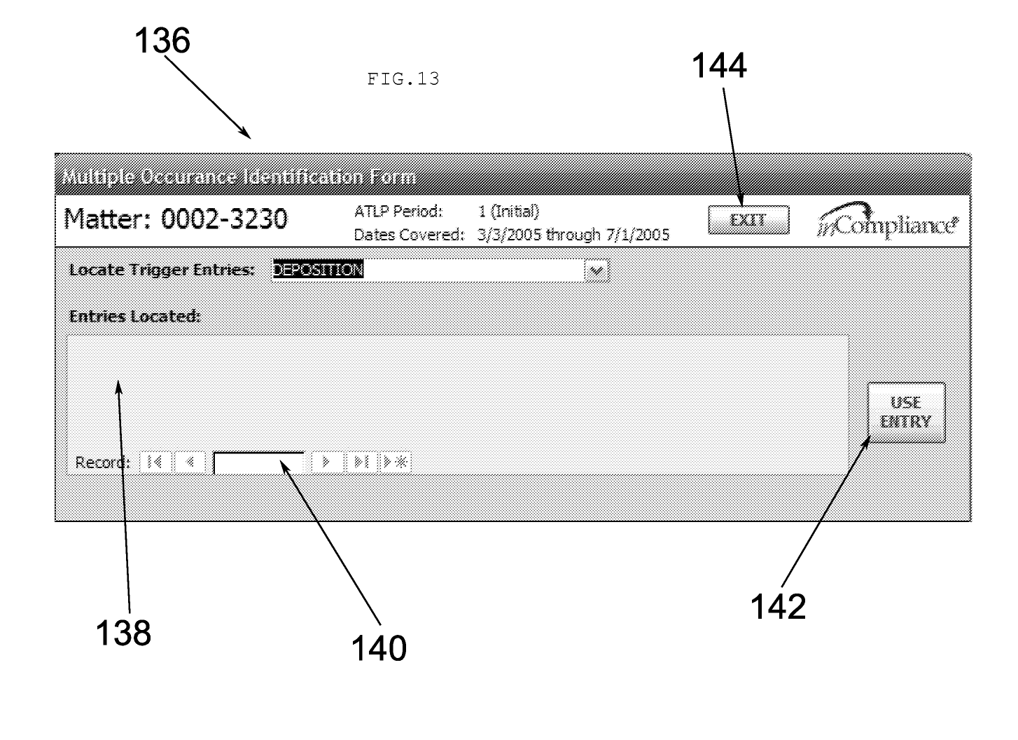

Next, is an illustrative example of the Multiple Occurrence Identification Form 136, see FIG. 13, the Multiple Occurrence form works very much like the main Guideline Identification form. The drop-down list contains a list of events, which trigger guideline items, which commonly occur more than once in any individual budget period. Take, for example, attendance at depositions. It would not be uncommon for Firm's staff to attend more than one deposition in any given budget period. In contrast, there will only be ONE time, for a given file and given budget period, where an updated budget and case report are due.

The Entries Found 138 shows the detail of the entries located by the system, based off of the item selected in the Locate Trigger Entries drop-down box 146.

The Records 140 show the total number of records located by the system. Record selectors may be used to move forward and backward through the applicable records.

When an appropriate entry is found, the user simply clicks the Use Entry 142 button. Doing so will add any and all applicable guideline dates to the Compliance History for this file. For example, if an entry is selected for “DEPOSITION”, the system will add a guideline date for a pre-deposition conference and a deposition report, both calculated according to guidelines and based off of the date the deposition was taken. The user may then return to the Compliance Item Identification form to find entries that meet these guideline dates.

Click Exit 144 to leave this form when all items have been located ad return to the Compliance Item Identification form.

The Locate Trigger Entries drop-down box 146 instructs the system which events you would like to locate applicable entries. For example, if “DEPOSITION” is selected; the system will search time records to find attendance at depositions, and will populate the Entries Located box with those items.

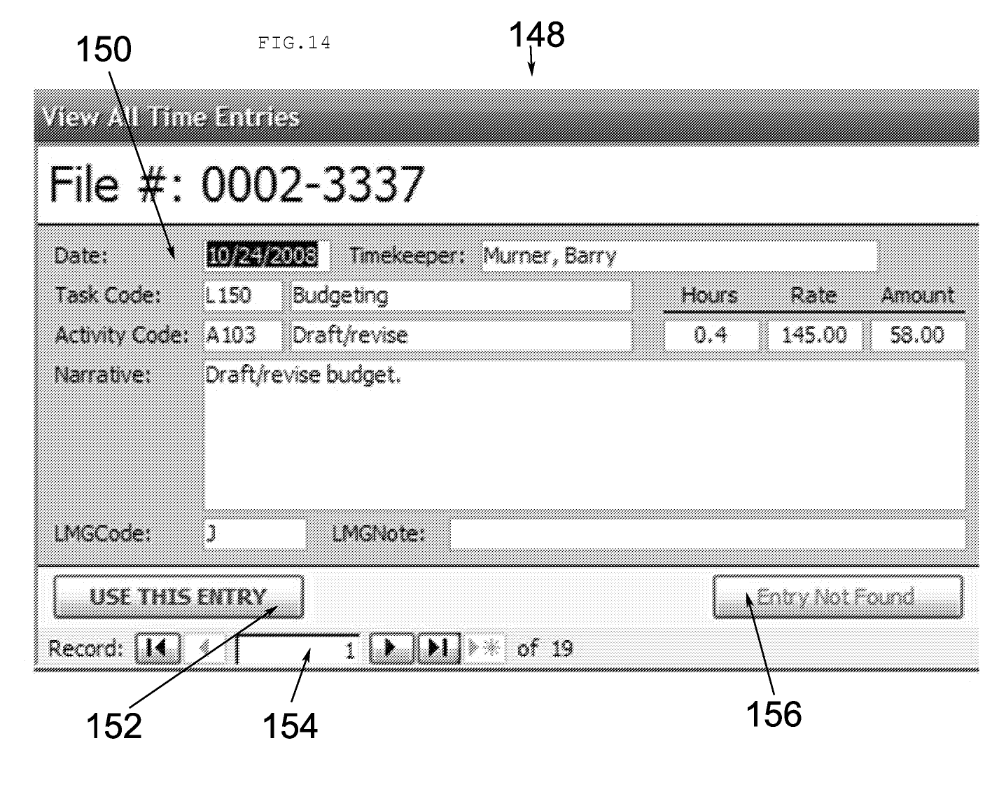

Finally, an illustrative example of the View All Time Entries 148, see FIG. 14. This form is used to search through all time entries in the 3^{rd} party timing keeping software. It is used when the Compliance Item Identification screen cannot locate an appropriate, matching time entry for a particular guideline item. This form will display all of the entries in the 3^{rd} party timing keeping software for the specified file and the applicable time period.

The form has several fields, for example: The Juris Entry 150 detailing of the 3^{rd} party timing keeping software time entry. The Use Entry 152 shown if it meets the guideline item from the Compliance Item Identification screen. The Records 154 shows total records found, and may be used to move between records. And finally, No Entry 156. If no entry can be found, click here to exit this form and return to the Compliance Item Identification form.

### Compliance Maintenance—Editing a Compliance Record

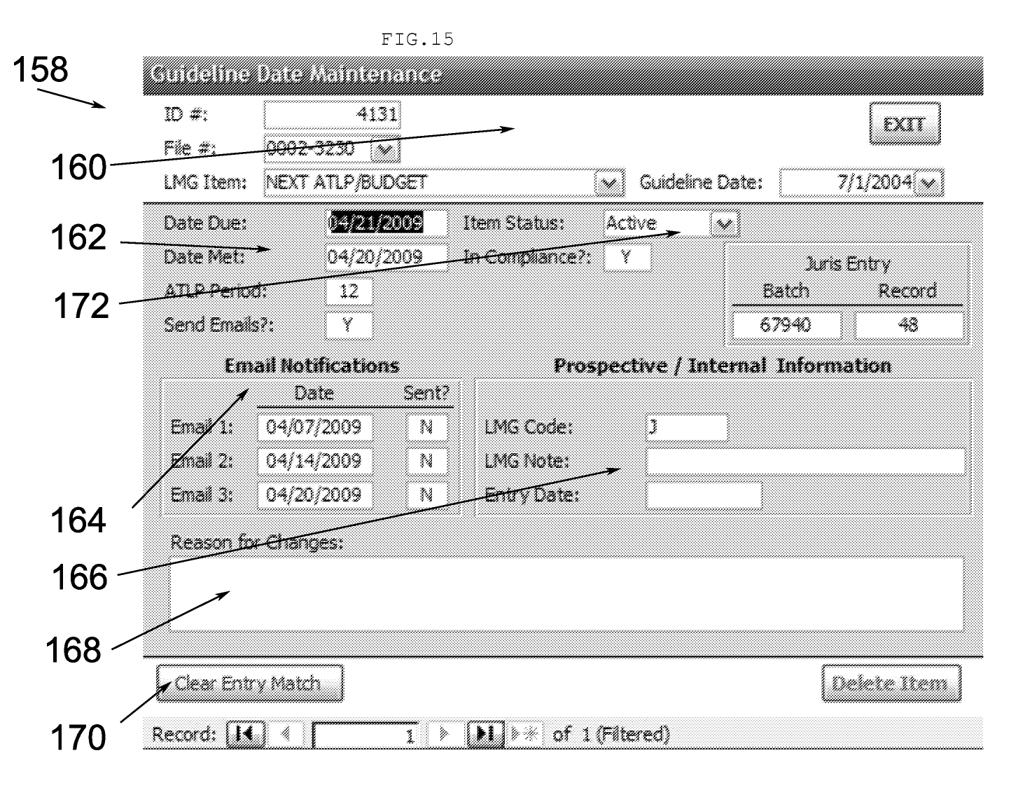

The next major exemplary function/form of the system is Editing a Compliance Record 158, see FIG. 15. The system administrator to edit and/or delete individual compliance records will use this form. The relevant screens or boxes are detailed below. This screen can only be accessed in edit mode by entering the administrative password.

The information in the Header Information 160 is marked as READ-ONLY and cannot be edited. It is provided for informational purposes only. The first field in the header is known as the litigation management guideline (LMG) ID#. Each and every guideline item in the system is given an ID#. In addition, every notification email contains this number. It allows for a quick and easy way for the administrator to search for an individual guideline item.

This Guideline Information 162 box contains the following information, each one showing whether the item is able to be edited:

Date Due—Date the guideline item is/was scheduled to be completed (EDITABLE);
Date Met—Date the guideline item was actually met (EDITABLE);
ATLP Period—The associated ATLP period for this item (NOT EDITABLE);
Send Notifications?—Instructs the system whether or not to send emails (EDITABLE);
In Compliance?—Is this guideline item itself in compliance with the litigation management guideline (EDITABLE);
Batch/Record—Indicates the associated billing entry from Juris (NOT EDITABLE).

The Notifications 164 box shows the dates of the three notification emails, and a flag as to whether they have been sent yet or not. These fields are editable. Please note that, in addition, the Email History table always contains a record of every email generated by the system.

The Prospective Information 166 shows information when the system identifies a prospective guideline item, it will retain these pieces of information for further use. These fields are not editable.

Any time a record is changed, the system provides the Reason for Change 168 area to document the reason(s) for the change. If the client agrees to an extension of the guideline item, the Date Due may be changed, and that approval would be noted here.

Click Clear Entry 170 to delete a record. PLEASE NOTE—Once a record has been deleted, there is no method for retrieving it. Please use caution when using this feature.

The Status 172 shows the status (Active or Inactive) of this guideline date. If a date item is marked as INACTIVE, it will no longer appear on any reports in the system, and it will not factor into any compliance calculations for either the associated matter or the firm as a whole. At any point in time, an inactive date may be changed to active and the item will appear on reports and in calculations.

### 2: Administrative Functions 26

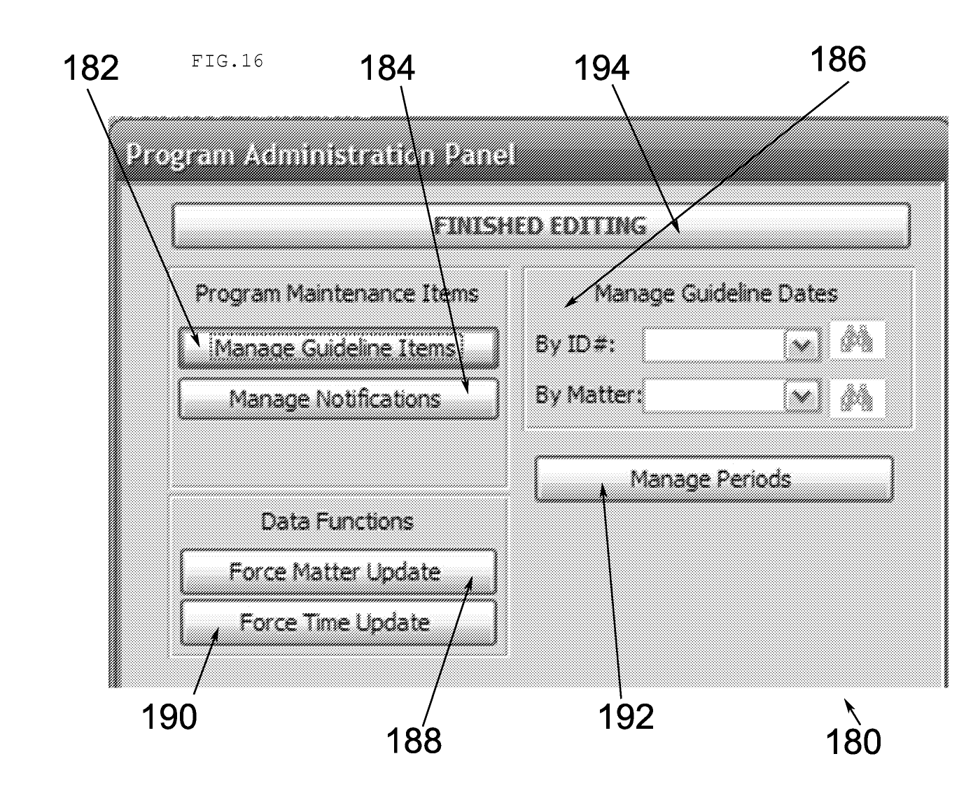

Looking now at the Administrative Functions 26 choice from the main menu screen 20. This menu choice will take the user to the Administrative functions entry screen. Once the proper administrative password is entered, the user will be presented with the choices of the Admin Panel button and the Program Mode buttons. The Admin Panel button will open up the Program Administration Panel 180; see FIG. 16, which will be used for 99% of all maintenance performed on the system and its databases. The Program Mode buttons 178 should be used with caution. When “Edit Mode” is selected, all of the database pieces will be displayed, including all form, report, and query designs. This feature is provided primarily for technical support use.

The Program Administration Panel window 180, see FIG. 16, provides access to all maintenance functions and forms contained in the system. Within this form, users find the following choices; Manage Guideline Items button 182, Manage Notifications button 184, Manage Guideline Dates section 186, Force File Update button 188, Force Time Update button 190, Manage Periods button 192, and Finished Editing 194.

Manage Guideline Items button 182 opens the litigation management guideline (LMG) Item Maintenance form. This form is used to set the defaults for each guideline item, and it instructs the system how to search for and apply guideline items.

Manage Notifications button 184 opens the Notification Maintenance form. This form provides many functions for maintaining your notification database.

Manage Guideline Dates section 186 users select to open a record(s) in the Guideline Date Maintenance form. Select either a guideline date ID# or a File number, then click the binoculars to open the form showing only that data.

Force File Update button 188 will force the system to access the third party software time and billing system and update itself with any new files added since the last successful update.

The Force Time Update button 190 will force the system to access the third party software time and billing system and update itself with any new/changed time entries since the last successful update.

The Manage Periods button 192. Use this button to access the ATLP Period Maintenance form, where the administrator can perform such actions as editing ATLP dates, deleting periods, recreating periods, and many more.

When you have finished with system maintenance, click Finished Editing 194 to return to the Main Menu.

The Program Administration Panel window 180 contains links to three other functional forms, these are; litigation management guideline (LMG) Items Maintenance, Notification Maintenance, and ATLP Period Maintenance, each detailed below.

### Administrative Functions—Litigation Management Guideline Items Maintenance

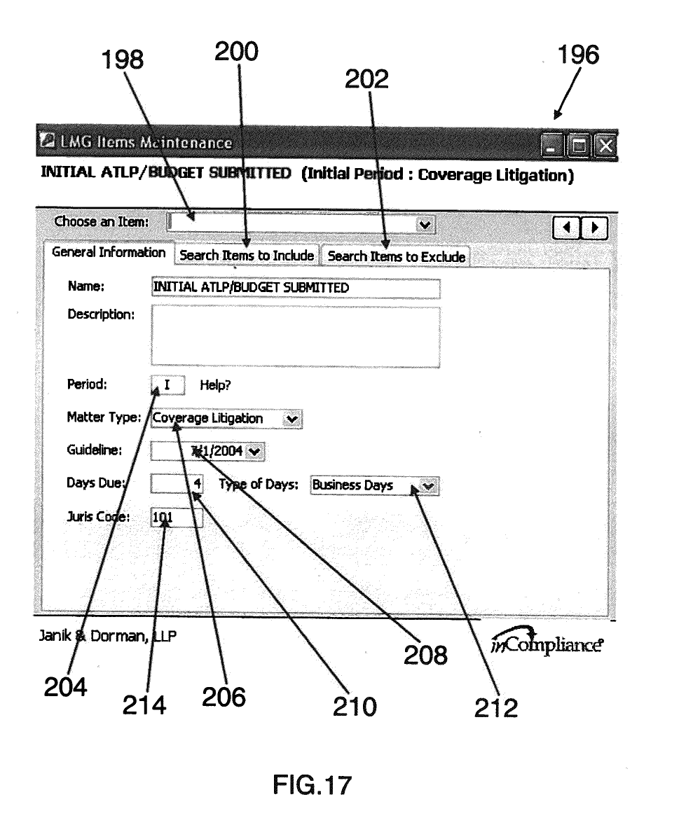

Litigation management guideline (LMG) Items maintenance screen 196, see FIG. 17, this form is really the ‘nuts-and-bolts’ of the system audit system. The data contained on this form, for each guideline item, instructs the system on how to search for time entries from the third party software time and billing system. This allows each firm to customize searches based on their individual billing guidelines. Within this screen, there are the following items/fields to choose from.

The Choose Item pull down selector 198 box displays each individual guideline item programmed into the system for the purpose of compliance auditing. As you will see, for compliance items that occur in more than one ATLP period (such as ATLP/Budget Submission) or items that are applicable to more than one type of file (such as Acknowledgment Letter, which applies to all 3 file types), there are individual guideline items for each period/file type.

The Included Items button 200 takes the user to another screen, detailed further below.

The Excluded Items button 202 takes the user to another screen, detailed further below.

The Period box 204 box contains an “I” for the initial ATLP period only, and an “S” indicates that the guideline item is applicable to subsequent ATLP periods. For example, an acknowledgment letter is generated only at the acceptance of the file; therefore it appears in the first (initial) ATLP period only. Other items, such as ATLP/Budget Submission, may appear in any or all ATLP periods.

The File Type 206 selects the type of file this guideline item should be applied against. The choices are: Litigation, Coverage Analysis, and Coverage Litigation.

From the Guideline pull down selector 208, the date of the guidelines to which this item is applicable. The system can store and process multiple guideline sets, as well as multiple versions of those guidelines.

The Days Due box 210 shows the number of days that the guideline item is due. This number can be positive (days AFTER a specific event, such as Assignment Date), or negative (days BEFORE a specific even, such as a Deposition or Trial).

The Days Type pull down selector 212 sets the type of days shown in the Days Due box. Can be either BUSINESS DAYS or CALENDAR DAYS. The system will use this in combination with the Days Due box to correctly calculate guideline item due dates.

The Juris Code box 214 shows the firm-specified code which will be used in the third party software time and billing system to identify a time entry which is associated with this guideline item.

### Litigation Management Guideline Items Maintenance—Included Items

The Included Items tab screen 214, is where the firm will go to enter and edit search terms which the system will use to look for time entries which match the guideline item. This screen contains main fields and one clickable button. The Text to Include field shows a list of each of the text items that the system will use to find entries. The system will look for these words/phrases within the narrative time entries. The search will include entries with ANY of the listed items, and is NOT case sensitive. To add a new text item, click on the Add Item box next to this section. To delete and item, highlight it, right-click and select DELETE ROW. If an item needs to be edited, simply make the change to the appropriate line right in this section. Changes will be saved and immediately used for audit functions.

In the Activity Codes to Include field 218 the system will limit its search to any UTBMS Activity Codes listed here. To add a new code, click the Add Item button to the right of this section. To delete a code, highlight it, right-click and select DELETE ROW. Changes will be saved and immediately used for all audit functions. Finally, the Add Item button is used to add new Text Entries or Activity Codes.

### Litigation Management Guideline Items Maintenance—Excluded Items

The Excluded Items tab screen 222, see FIG. 21, is where the firm will go to enter and edit search terms which the system will use to look for time entries which match the guideline item. It includes two main fields and one clickable function.

The Text to Exclude box 224. Text items in this list will be used to exclude any possible time entries from the third party software time and billing system when the system performs its searches. Entries, which contain ANY of these text items, will be excluded from results displayed, and the search is NOT case sensitive. To add a new text item, click on the Add Item box next to this section. To delete and item, highlight it, right-click and select DELETE ROW. If an item needs to be edited, simply make the change to the appropriate line right in this section. Changes will be saved and immediately used for audit functions.

The Activity Codes to Exclude box 226 will cause the system to exclude from its search any entries, which contain the UTBMS Activity Codes listed here. To add a new code, click the Add Item button 228 to the right of this section. To delete a code, highlight it, right-click and select DELETE ROW. Changes will be saved and immediately used for all audit functions.

The Add Item button 228 is used to add new Text Entries or Activity Codes.

### Administrative Functions—Notification Maintenance

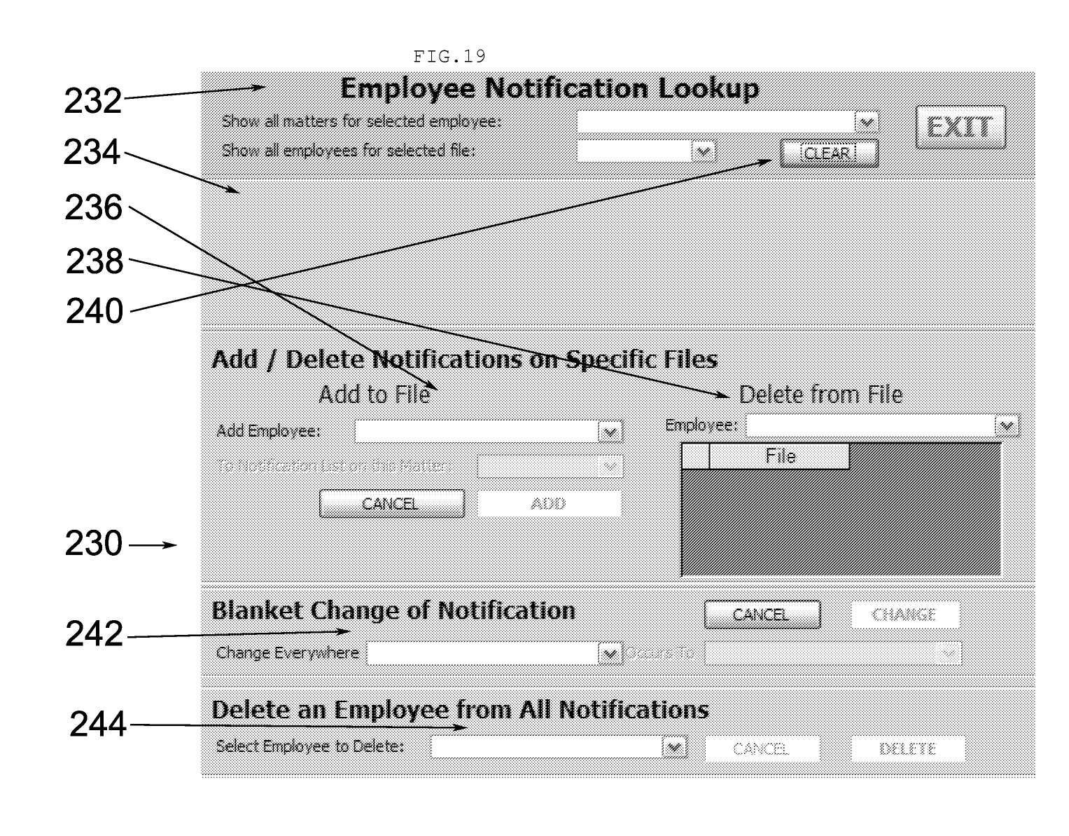

The Notification Maintenance screen 230, see FIG. 19, is the notification maintenance screen is where the compliance administrator can make blanket changes to which users are notified (via email alerts) to compliance issues.

Using either of the two drop-down lists in the Notification Lookup box 232, a user may view notification data. When the first search box is used, the section immediately below this will show all files where the selected employee is listed in the notification file. When the second is used, the section will show all employees that are notified on the selected file. The information displayed is for informational purposes only, and no changes can be made here.

The Data List box 234 will show the detail based on which search box was used in the Notification Lookup box 232 above. Again, no information can be changed in this area.

The Add an Employee to Notification List on a File section 236 is where users choose an employee in the first drop-down box, and then select a file number in the second. Click ADD to insert that employee into the notification list on that file. Employee will immediately begin to receive any future email notifications on the file.

The Delete an Employee from Notification List on a File 238 is where users choose an employee from the drop-down list, and the box will show all files where the employee receives notifications. To delete from a file, highlight the applicable row, right-click and select DELETE ROW. Changes are made immediately and the employee will receive no further notifications on that file.

The Clear button 240 clears any items previously searched for in the top search boxes.

The Blanket Change section 242 allows the user to change notifications for one employee to another. Use this when one employee takes over all files from another to quickly and easily change the notification list.

Delete Employee from Notifications section 244 is where users can select an employee and click DELETE to remove that employee from any and all notifications on all files. This function will primarily be used when an employee terminates employment with the firm.

### Administrative Functions—ATLP Period Maintenance

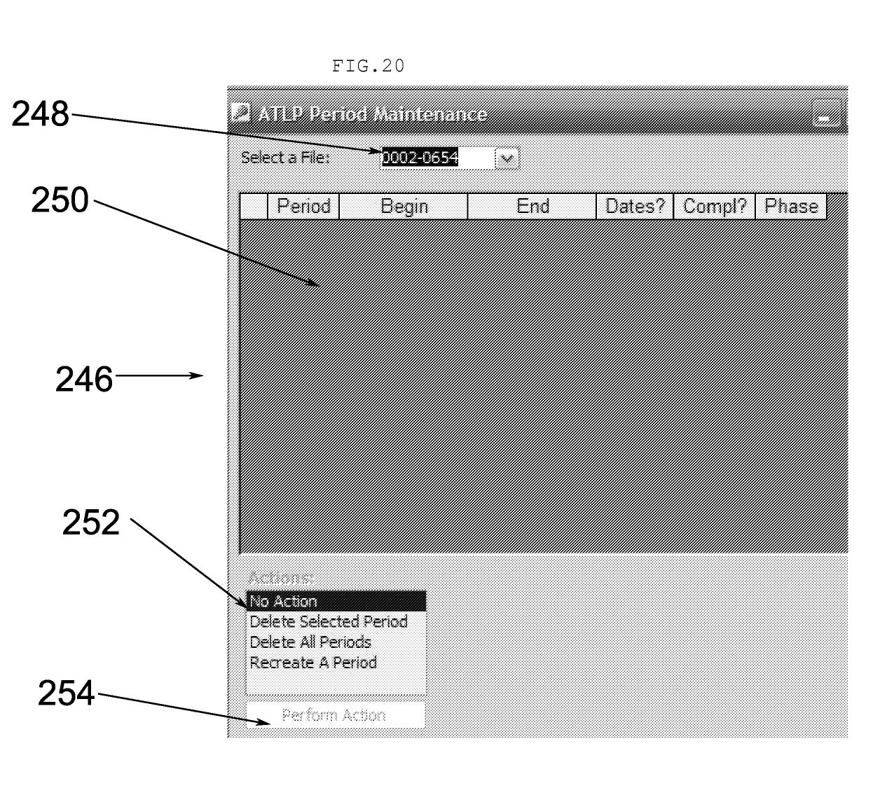

ATLP Period Maintenance screen 246, see FIG. 20, This form will be used to make edits to existing ATLP periods, delete ATLP periods, and recreate ATLP periods previously deleted. To choose a file from the list to edit ATLP periods use the File Selection pull-down selector 248.

The ATLP Period List window 250 will show a list of all of the ATLP periods for the file chosen in this window. Within this list, the following information may be edited: Begin Date—ATLP period start date; End Date—ATLP period end date; Dates?—Have guideline dates been generated for this period (Y/N); Compl?—Has the audit been finalized for this period (Y/N). Use the Actions Panel 252 to choose an action to perform on the list in the above list. Select “Delete Selected Period” to delete the ATLP highlighted in the list, in addition to any guideline dates that have been generated and/or identified. Select “Delete All Periods” to delete ALL ATLP periods shown in the list above, in addition to any guideline dates that have been generated and/or identified. Select “Recreate a Period” to rebuild an ATLP period previously deleted from the list. Please note that this should NOT be used to add additional periods subsequent to those shown above. To perform that function, please use the “Update Periods” button on the Compliance Analysis & Reporting screen. Finally, click on the Perform Action button 254 to perform the action selected in the Actions Panel 252.

### Example Reports

As a set of illustrative examples, the system can produce a number of reports, using a report type rule set, based upon the data both directly entered into the system, the data pulled from the third party time keeping software package, emails from the email program, or any combination thereof. The following example reports are detailed below for Example 1: Compliance Audit Report, Example 2: Budget Reconciliation Reports, Example 3: Activity Code Report, Example 4: Summary Activity Code Report, Example 5: Detail Multiple Attendance Report, and Example 6: Invalid Time Descriptions.

### Example 1 is a Compliance Audit Report Sheet 256, See FIG. 21.

This report shows exactly where a file stands regarding compliance analysis for the selected period. It is the likely the primary report that will be used in assessing guideline compliance. It contains five main sections.

First, the Header section 258 contains the report name, file, ATLP period, and the date and time the report was generated. This information is contained on all the system reports. Second the Juris Information section 260 that shows real-time file information pulled directly from the third party time and billing system. It is standard on all the system reports. Thirdly, the In Compliance section 262 shows the detail for each guideline item that was met in a timely fashion. The detail shows the guideline item name, date due, date met, variance (in days) and the guideline item's setup information. Additionally, the detail shows the actual billing entry from the third party time and billing system. Fourthly, the Out of Compliance section 264 contains the same information as above, but solely for guideline items not met in a timely fashion. And lastly, the Future Items section 266 shows both future guideline items and any guideline items that hove not been identified as completed.

### Example 2 is a Set of Two Budget Reconciliation Reports.

They are: Budget Report for one Period (page 1) and Budget Report for Entire File (page 2). The reports are structurally exactly the same, except for the timing of the data included. As the name indicates, the Period budget report compares only the selected ATLP period's actual numbers against that period's budget. The Entire Budget report shows the same comparison for the entire life of the file.

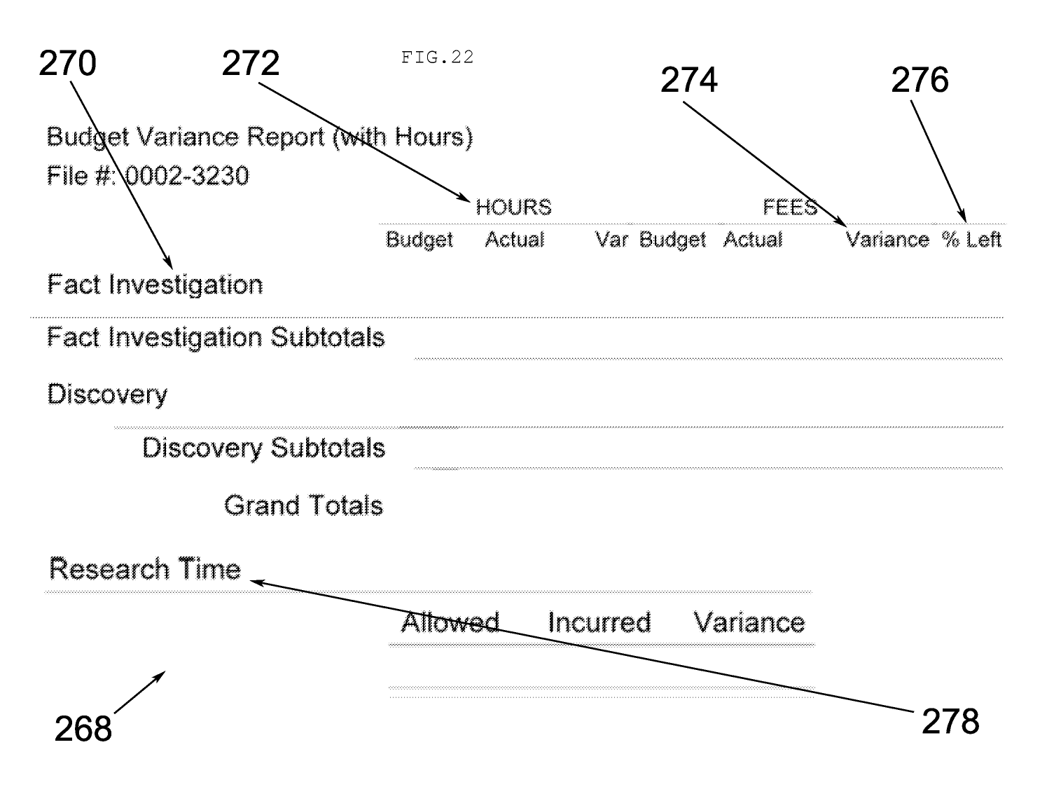

### Budget Report—Page 1 268, See FIG. 22.

UTBMS Format 270 The budget reports print in standard UTBMS format, consistent with the requirements of many clients. This breaks down the case by task and phase. The Hours columns 272 Shows a breakdown of the budgeted hours versus the actual hours, and variance, for each task code. The Fees columns 274 Shows the budgeted versus actual fees incurred, and variance, for each task code. The % Remaining column 276 shows what percentage of each task's budget is remaining in the current period. The Research time summary 278 Details the total research time allowed versus what has been used, in addition to the variance. These numbers are broken down by task code on page 2 of the report.

### Example 3 is an Activity Code Report—Summary Page

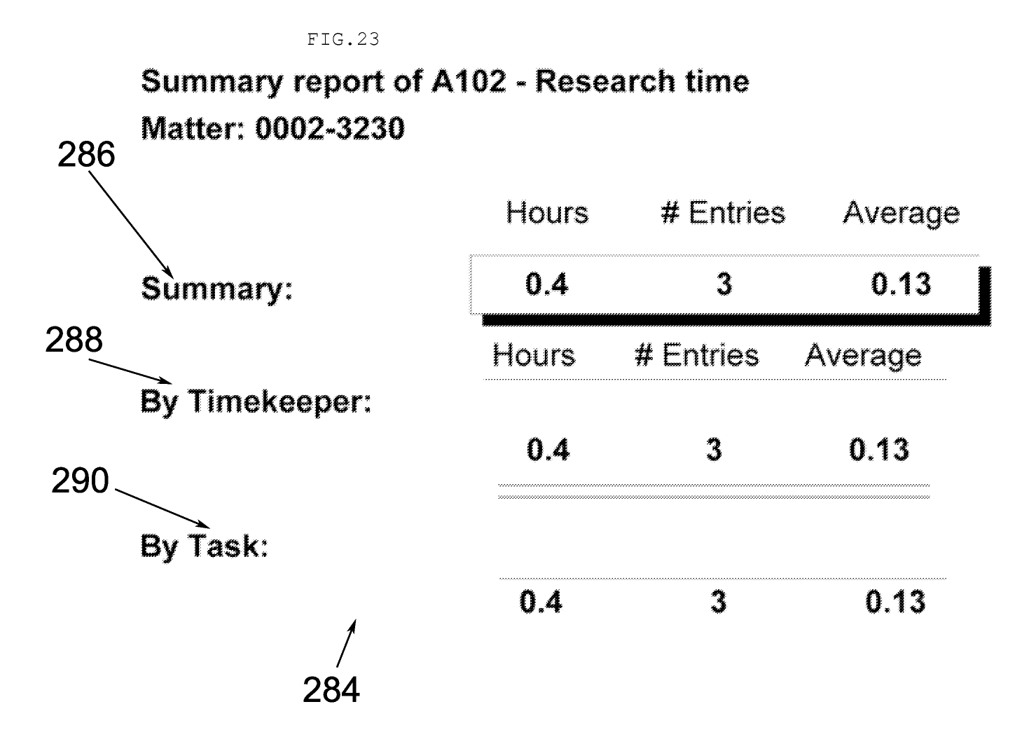

### Activity Code Report—Summary Page 284, See FIG. 23

In this report, the Activity Code Report—Summary page 284, it shows a summary of time entries for the UTBMS activity code selected. The Summary field section 286 shows the total hours, number of time entries, and average hours for the selected activity code and period. The Timekeeper section 288 shows the same hours shown in the summary section above, but breaks them out first by timekeeper and then by UTBMS task code. The Task section 290 shows the same numbers as the summary, but it breaks the numbers down by UTBMS task code first, then by timekeeper.

### Example 4 is an Activity Code Report—Detail Page

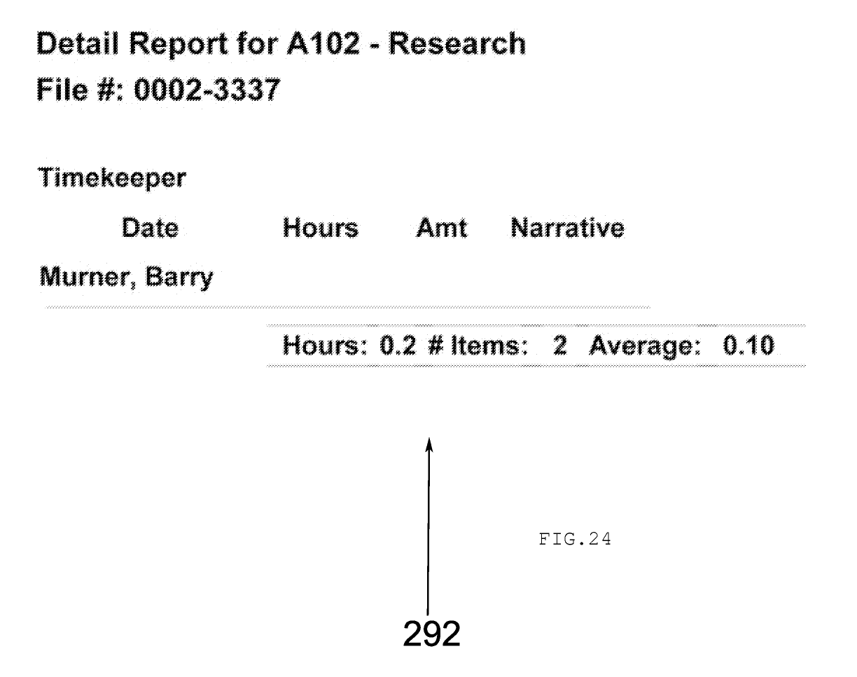

### Activity Code Report—Detail Page 292, See FIG. 24

This report contains the same numbers as the Summary report; however, it shows the actual third party time and billing software billing entries for each item. This allows the user to drill down all the way to the original time entry to find discrepancies.

### Example 5 is a Multiple Attendance Report

### Multiple Attendance Report Page

As many clients will not pay for more than one firm member to attend many events (e.g. depositions, pretrial hearings, etc.), it is important to identify potential duplicate billings if they occur. This report attempts to locate more than one employee attending the same event, and alerts you to it so that corrections, if warranted, can be made before the client is billed for the time. The report is sorted first by date, then will show the actual third party software time entries which the system feels may show multiple attendance.

### Example 6 is an Invalid Time Descriptions Report

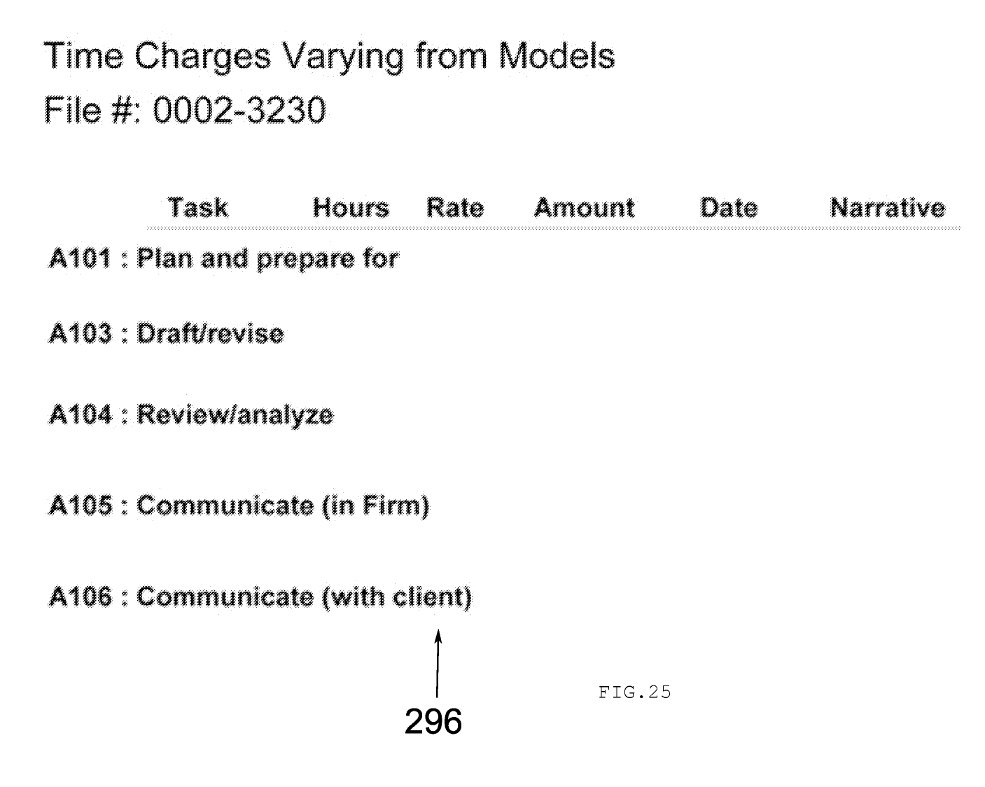

### Invalid Time Descriptions Report Page 296, See FIG. 25

The user can set up certain parameters for narrative in time entries, based upon the UTBMS activity code used. The system can then generate a report that shows any variation from those prescribed model entries. This can be highly useful in maintaining a consistent look to the firm's billing. The report is subdivided by UTBMS activity code, then by employee, and finally by UTBMS task code.

### Example 7 is a Consolidated Compliance Report.

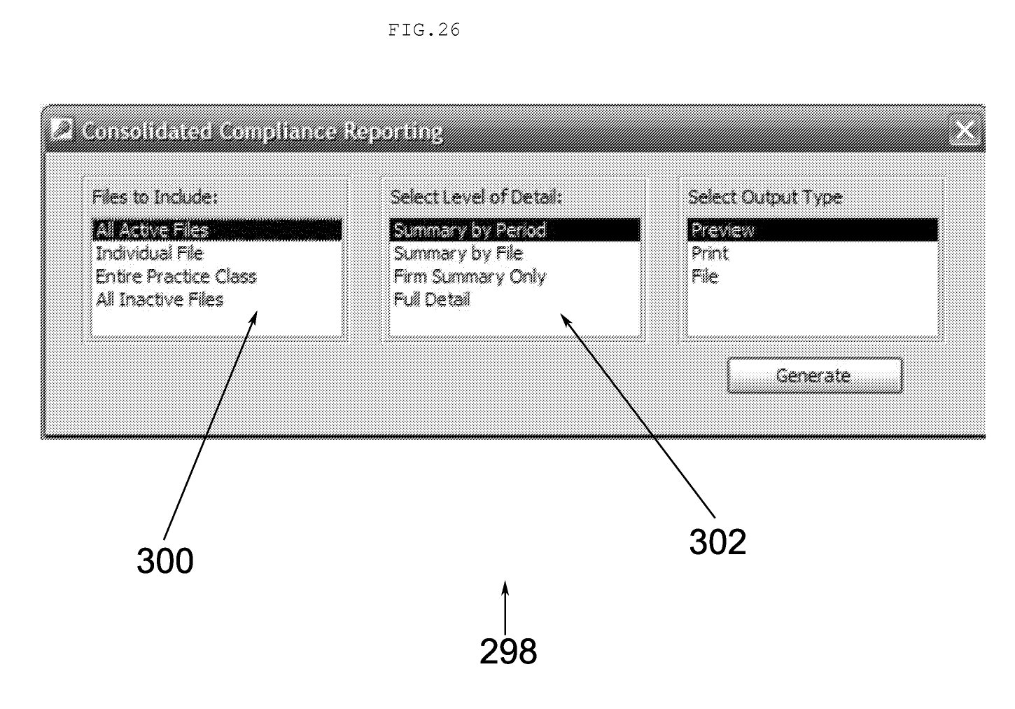

### Consolidated Compliance Reporting Form 298, See FIG. 26.

This form will be used to generate compliance reports that pertain to more than one file or ATLP period. This is as opposed to the reports on the Reporting tab of the Compliance Analysis & Reporting screen, which provide reporting for only one file and ATLP period per report.

The Select Files screen 300 include four choices for files to include on the report:

All Active Files—Will include any files in the system whose status is marked as ACTIVE
Individual File—Will provide a drop-down list of all files in the system (see view here)
Entire Practice Class—Will provide a drop-down list of all practice classes in the system (see view here) All Inactive Files—Will include all files in the system whose status is marked as anything other than ACTIVE Selecting from this list will limit the report data to the selection made.

Select Detail screen 302 will determine the level of detail shown on the corresponding report. The choices are listed below, along with a link to a sample report showing the actual output. The choices are: Summary by Period, Summary by File, Firm Summary Only, and Full Detail.

Once the user selects from the two above-mentioned screens, a report will be generated accordingly.

### Automated Audit Process

In addition to the manual audit process, the system performs a series of functions each time a batch processing run is completed, generally each evening. These functions serve to ensure that the system database is up-to-date with the most recent information from the third party timekeeping software package. The system will then process these entries, looking for any prospective guideline dates that must be added to the system. In addition, the system will search through time records and attempt to match entries to outstanding guideline items.

### Automated Audit Process EXAMPLE:

On July 3, an attorney attends the deposition of Mr. Smith. Let's assume that the attorney's time is entered into the 3^{rd} party time keeping software database package on that same day. Here is the entry placed into the 3^{rd} party time keeping software database package:

### Date: Jul. 3, 2006

### Attorney: John Jones

### Task Code: L330 (Depositions)

Activity Code: A109 (Appear for/attend)
Narrative: Attend deposition of Mr. Smith.
litigation management guideline Note: Smith
On the evening of July 3, the system will process this new time entry. The system will find that attorney Jones attended the deposition of Mr. Smith and will set up two new guideline items, as follows:

### Item 1

### Guideline Item: Pre-Deposition Conference

Date Due: Jun. 27, 2006 (according to guidelines, this item is due 5 business days prior to deposition)
litigation management guideline Note: Smith
First Notification Date: Jul. 3, 2006 (notify the same day the entry was located)
Subsequent Notifications: Each evening until item is satisfied

### Item 2

### Guideline Item: Deposition Report

Date Due: Jul. 14, 2006 (according to guidelines, this item is due 10 business days following deposition)
litigation management guideline Note: Smith
First Notification Date: Jul. 3, 2006 (notify the same date the entry was located)
Second Notification: Jul. 11, 2006 (3 business days prior to due date)
Third Notification: Jul. 13, 2006 (1 business day prior)
Subsequent Notifications: Each evening until item is satisfied

As can be seen, on the evening of July 3, two emails will be generated to attorney Jones and any other individual listed on the notification list for this file. Let's assume that on July 12 attorney Jones completes a deposition report and the associated time entry is placed in the 3^{rd} party time keeping software database package on that day. On the evening of the 12th, the system will find this time entry and, assuming the entry was input with the correct task code, activity code, and litigation management guideline Note. In that case, the system will mark Item 2 (above) as complete with a date met of July 12. The system will stop generating emails for this item. In addition, the system will tie the actual 3^{rd} party time keeping software database package entry to Item 2 so that the entry will appear on the Compliance Analysis report. The system will perform this same search-and-match each evening on every outstanding.

The explanations and illustrations presented herein are intended to acquaint others skilled in the art with the invention, its principles, and its practical application. Those skilled in the art may adapt and apply the invention in its numerous forms, as may be best suited to the requirements of a particular use. Accordingly, the specific embodiments of the present invention as set forth are not intended as being exhaustive or limiting of the invention. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes.

What is claimed is:

1. A method of reporting legal matters comprising the steps of:
(a) Inputting into a database a rule set of predetermined requirements as to form and content of a of a legal matter;
(b) inputting actual information pertaining to the legal matter;
(c) comparing the form and content of the inputted information to the rule set;
(d) signaling a user when a difference is detected between the actual information and the rule set;
(e) optionally modifying the input information to conform with the rule set;
(f) optionally overriding the modification of the input information; and
(g) generating a report of the legal matter.

2. A computer implemented method for tracking and auditing litigation guideline compliance for an insurance law practice, the steps comprising:
(a) providing an electronic interface for a user to input: time entries, written descriptions, contact information, budgets, expenditures, emails and practice class of work completed by an attorney or employee as it relates to an insurance matter;
(b) maintaining an electronic database on at least one server that includes a software package for storing and sorting input time entries, written descriptions, contact information, budgets, expenditures, and practice class into an electronic data set;
(c) inputting at least one input time entries, written descriptions, contact information, budgets, expenditures, and practice class into the electronic database to create the electronic data set;
(d) maintaining an email database on at least one server that includes a email software package for providing email communication within and outside of the server;
(e) maintaining at least one internet connection for at least providing email communication capability;
(f) maintaining a compliance software package that communicates with the electronic database and the email database to acquire the electronic data sets and emails as input into the compliance software package;
(g) maintaining a compliance software package on the server that communicates with the email database to acquire the email data sets as input into the compliance software package;
(h) maintaining a compliance software package including at least one of: a litigation management guideline dates rule set, a ATLP rule set; a budget rule set, a report type rule set, a task description rule set and a administrative function rule set;
(i) providing an electronic interface for requesting a report from the compliance software package;
(j) communicating the electronic data set from the electronic database to the compliance software package;
(k) selecting a report type to be generated;
(l) calculating inputs and outputs based upon the report type rule set;
(m) selecting the electronic data set to audit;
(n) selecting at least one time period to audit;
(o) selecting an output type;
(p) instructing the compliance software package to begin applying the rule sets of step (h) based upon the report type selected to the selected electronic data set;
(q) generating a report base upon the report type and output type selected; and
(r) communicating the report upon the output type selected.

3. The computer implemented method of claim 2, further including the step of emailing the manual audit report to a set of predetermined recipients.

4. The computer implemented method of claim 2, wherein the reports are automatically generated at predetermined time intervals per the administrative rule set.

5. The computer implemented method of claim 2, further including the step of listing a set of email communications associated with the report.

6. The computer implemented method of claim 2, wherein the output type is a printed document via a computer printer.

7. The computer implemented method of claim 2, wherein the output type is a displayed document via a computer screen.

8. A computer implemented method for tracking and auditing litigation guideline compliance for an insurance law practice, the steps comprising:
(a) providing an electronic interface for a user to input: time entries, written descriptions, contact information, budgets, expenditures, emails and practice class of work completed by an attorney or employee as it relates to an insurance matter;
(b) maintaining an electronic database on at least one server that includes a software package for storing and sorting input time entries, written descriptions, contact information, budgets, expenditures, and practice class into an electronic data set;
(c) inputting at least one input time entries, written descriptions, contact information, budgets, expenditures, and practice class into the electronic database to create the electronic data set;
(d) maintaining an email database on at least one server that includes a email software package for providing email communication within and outside of the server;
(e) maintaining at least one internet connection for at least providing email communication capability;
(f) maintaining a compliance software package that communicates with the electronic database and the email database to acquire the electronic data sets and emails as input into the compliance software package;
(g) maintaining a compliance software package on the server that communicates with the email database to acquire the email data sets as input into the compliance software package;
(h) maintaining a compliance software package including: a litigation management guideline dates rule set for each client, a ATLP rule set for each client; a budget rule set for each client, a report type rule set for each client, a task description rule set for each client and a administrative function rule set;
(i) providing an electronic interface for requesting a report from the compliance software package;
(j) communicating the electronic data set from the electronic database to the compliance software package;
(k) selecting a report type to be generated;
(l) selecting the client that the report relates to;
(m) calculating inputs and outputs based upon the report type rule set and the client;
(n) selecting the electronic data set to audit;
(o) entering an administrative password;
(p) editing the electronic data set within the compliance software package if required;
(q) communicating changes to the electronic data set to the electronic database;
(r) selecting at least one time period to audit;
(s) selecting an output type;
(t) instructing the compliance software package to begin applying the rule sets of step (h) based upon the report type selected to the selected electronic data set;
(u) generating a report base upon the report type and output type selected; and
(v) communicating the report upon the output type selected.

9. The computer implemented method of claim 8, further including the step of emailing the manual audit report to a set of predetermined recipients.

10. The computer implemented method of claim 8, wherein the reports are automatically generated at predetermined time intervals per the administrative rule set.

11. The computer implemented method of claim 8, further including the step of listing a set of email communications associated with the report.

12. A computer implemented method for tracking and auditing litigation guideline compliance for an insurance law practice, the steps comprising:
(a) providing an electronic interface for a user to input: time entries, written descriptions, contact information, budgets, expenditures, emails and practice class of work completed by an attorney or employee as it relates to an insurance matter;
(b) maintaining an electronic database on at least one server that includes a software package for storing and sorting input time entries, written descriptions, contact information, budgets, expenditures, and practice class into an electronic data set;
(c) inputting at least one input time entries, written descriptions, contact information, budgets, expenditures, and practice class into the electronic database to create the electronic data set;
(d) maintaining an email database on at least one server that includes a email software package for providing email communication within and outside of the server;
(e) maintaining at least one internet connection for at least providing email communication capability;
(f) maintaining a compliance software package that communicates with the electronic database and the email database to acquire the electronic data sets and emails as input into the compliance software package;
(g) maintaining a compliance software package on the server that communicates with the email database to acquire the email data sets as input into the compliance software package;
(h) maintaining a compliance software package including: a litigation management guideline dates rule set for each client, a ATLP rule set for each client; a budget rule set for each client, a report type rule set for each client, a task description rule set for each client and a administrative function rule set;
(i) providing an electronic interface for requesting a report from the compliance software package;
(j) communicating the electronic data set from the electronic database to the compliance software package;
(k) entering an administrative password to enter a program administration function;
(l) editing at least one of the rule sets of step (h);
(m) exiting the program administration function;
(n) selecting a report type to be generated;
(o) selecting the client that the report relates to;
(p) calculating inputs and outputs based upon the report type rule set and the client;
(q) selecting the electronic data set to audit;
(r) entering an administrative password;
(s) editing the electronic data set within the compliance software package if required;
(t) communicating changes to the electronic data set to the electronic database;
(u) selecting at least one time period to audit;
(v) selecting an output type;
(w) instructing the compliance software package to begin applying the rule sets of step (h) based upon the report type selected to the selected electronic data set;
(x) generating a report base upon the report type and output type selected; and
(y) communicating the report upon the output type selected.

13. A software package for tracking and auditing litigation guideline compliance for an insurance law practice comprising:
a database module to store an information set of time, description and expense entries;
a rule set module to store at least one rule set of predetermined time, description and expense requirements;
a report module to store and produce at least one set of predetermined set of reports;
a compliance module used to compare the information set from the database module to the at least one rule set and create a compliance data set; and
an output module to create at least one report based upon the compliance data set and the at least one set of predetermined set of reports.
